(19) United States
(12) Patent Application Publication
(10) Pub. No.: US 2013/0218636 A1
(43) Pub. Date: Aug. 22, 2013

(54) SYSTEM FOR DETERMINING A TRADE-IN VALUE OF AN ITEM BASED ON A MATCH TO A DATABASE OF CUSTOMERS

(71) Applicant: HCD Software LLC, (US)

(72) Inventors: Charles Richard Colson, Weddington, NC (US); Rafael A. Duluc, Charlotte, NC (US)

(73) Assignee: HCD Software LLC, Charlotte, NC (US)

(21) Appl. No.: 13/841,915

(22) Filed: Mar. 15, 2013

Related U.S. Application Data
(63) Continuation-in-part of application No. 12/626,013, filed on Nov. 25, 2009.
(60) Provisional application No. 61/764,984, filed on Feb. 14, 2013.

(51) Int. Cl. G06Q 30/02

(52) U.S. Cl. CPC G06Q 30/0206
USPC 705/7.31

(57) ABSTRACT

Methods, systems and computer program products for verifying a trade-in amount that a user can offer a customer for an item desired to be traded-in. A quantity of potential buyers is determined for the trade-in item by accessing a customer database to identify customers currently possessing similar items to the trade-in item. The quantity of potential customers is used to determine whether a trade-in amount for the trade-in item may be offered to the customer as part of a deal associated with the trade-in item.

### FIELD

In general, embodiments herein disclosed relate to methods, apparatus and computer program products for identifying potential customers of vehicles in inventory and, more specifically, determining potential buyers for an identified vehicle that is available to a user where the determination of potential buyers is at least partially based on information that is specific to the potential buyers.

### BACKGROUND

Traditionally, entities that sell, or distribute vehicles, such as automobile dealerships, automobile manufacturers and the like have been limited in their ability to effectively offer their vehicle inventory to previous customers and/or prospective customers, despite the fact that such entities have access to information, often unique information, about their previous and prospective customers. In many instances, such entities have typically relied on the product itself as the means for trying to assure customer allegiance in the form of repeated purchases/leases from the same manufacturer or dealership. In this regard, the mindset has been that, if the customer has been pleased with his/her current vehicle in terms of value, performance and reliability, as well as pleased with the service provided by the dealership over the lifetime of the vehicle, the customer is likely to return to the same dealership for subsequent vehicle purchases/leases.

In such a scenario, it is only when, and if, the previous customer returns to the vehicle dealership that a potential vehicle proposal is offered to the returning customer based on his/her current needs or other information specific to the customers. This typically transpires by having the previous customer interface with a sales associate so that the sales associate can gain an appreciation of the customer's interest in obtaining an alternate vehicle, e.g., what type of vehicle the customer desires, what type of personal financial situation the customer is currently experiencing that may affect vehicle choice and any other relevant information that may inform the seller of the customer's interests, the type of vehicle that best suits the customer needs, potential financial terms, etc.

In today's electronically networked world, the ability to obtain and maintain information, and more specifically information about customers or prospective customers of vehicles, is rapidly increasing. Not only is an increasing amount of information being accumulated and stored by manufacturers, dealers and financial institutions, the ability to efficiently search, match, retrieve, etc. large quantities of this information is becoming increasingly more realistic. For example, vehicle dealerships have access to information about a customer's current vehicle, such as the make and model of the vehicle, the vehicle's service records, the customer's address, financial circumstances of the customer, previous vehicle financial transaction data, and the like. Such information is available to the dealers, manufacturers and financial institutions through internally maintained databases, such as a dealership's Customer Relationship Management (CRM) system, dealership service records, as well through external databases including ADP (Automatic Data Processing), Reynolds & Reynolds databases and the like. In addition, the entities have access to their own unique, customer specific data. Additionally, vehicle dealerships, manufacturers or financial institutions can access and mine data from any other current, future known and/or future accessible data base. Such auxiliary databases may be instrumental in providing data to a vehicle dealership, manufacturer or financial institution which it can then use to determine prospective customers.

Therefore, a need exists to develop methods, apparatus, computer program products and the like which provide for potential vehicle customers to be determined for an inventory of identified vehicles and more specifically, a dealership's and/or manufacturer's and/or financial institution's previous customers. The desired methods, apparatus, computer program products and the like can be an automated process that allows for users, such as dealerships or manufacturers to efficiently identify prospective customers for vehicle inventory or to effectively contact those identified prospective customers, including constructing customized potential vehicle proposals that address the prospective customer's particular circumstances, including the financial obligations surrounding the prospective customer's current vehicle and the like. As a means of identifying prospective customers, the desired methods, apparatus, computer program products and the like should have access to customer databases and any other databases that may provide insight into the customer's current status, including current vehicle status, the customer's current vehicle financial transaction obligations and/or the customer's current needs.

### SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Methods, apparatus and computer program products are defined that provide for verifying/authorizing (e.g., assessing the risk associated with increasing the trade-in amount) and/or determining a vehicle trade-in amount that can be offered to a vehicle buying/leasing customer based on a determination of the quantity (i.e., the number) of potential buyers of the vehicle being traded-in. In specific embodiments of the invention, the number of potential buyers for a vehicle being traded-in may be determined while the customer is currently negotiating a vehicle deal that includes the trade-in vehicle, for example, at the while the customer is at the dealership or while the customer is actively negotiating via email or the Internet. By providing users, such as dealerships, the ability to determine the number and, in some embodiments, identity of potential buyers for the vehicle being traded-in, the dealer can more accurately assess or authorize a trade-in amount that can be offered to the customer who is trading his/her vehicle. Such insight into the number of potential buyers of the vehicle being traded-in not only allows the users to accurately assess a vehicle trade-in amount and the amount the dealer should be able to re-sell the vehicle for but in many instances provides for the dealer to offer a higher trade-in amount, and in some embodiments a best available trade-in amount, than would otherwise be afforded to the customer who is trading in his/her vehicle. Moreover, the aspect of the invention that provides for the additional trade-in amount to be authorized or determined while the customer is at the dealership, or otherwise actively negotiating the buying or leasing of a vehicle, is a benefit that greatly influences the user's ability to close the deal.

A system for verifying a trade-in amount that a user can offer a customer for an item desired to be traded-in defines first embodiments of the invention. The system includes a computing platform having a memory and a processor in communication with the memory. The system additionally includes a customer database stored in the memory, accessible by the processor and configured to store customer information for a plurality of customers, including information related to items currently possessed by the customers. The system additionally includes a potential buyer identifier application stored in the memory, executable by the processor and configured to determine a quantity of potential buyers for a trade-in item. The potential buyers are determined by accessing the customer database to identify customers currently possessing similar items to the trade-in item. The quantity of potential customers is used to determine whether a trade-in amount for the trade-in item may be offered to the customer as part of a deal associated with the trade-in item.

An apparatus for locating information used by a vehicle dealer in determining a trade-in vehicle amount that the vehicle dealer may offer a customer having a trade-in vehicle defines second embodiment of the invention. The apparatus includes at least one computing device having a memory and a processor in communication with the memory. The apparatus further includes a potential buyer identifier application stored in the memory, executable by the processor and configured to determine, while the customer is negotiating a vehicle deal, a quantity of potential buyers for the trade-in. The potential buyers are determined based on information available to the vehicle dealer that relates to potential buyers who have a current vehicle that is similar in at least one respect to the trade-in vehicle. The apparatus further includes a trade-in vehicle amount determination application stored in the memory, executable by the processor and configured to determine the trade-in vehicle amount that may be offered to the customer while the customer is negotiating the vehicle deal based on the quantity of potential buyers that are determined.

In specific embodiments of the apparatus the potential buyer identifier application is further configured to determine the quantity of potential buyers based on the potential buyers being able to be offered the trade-in vehicle at one of a same monthly payment amount or a lower monthly payment amount than the potential buyer currently pays for his/her current vehicle.

In other specific embodiments of the apparatus the potential buyer identifier application is further configured to determine the quantity of potential buyers based on the potential buyers having a current vehicle that is a same make and model and a same or earlier model year as the trade-in vehicle.

In still further specific embodiments of the apparatus, the potential buyer identifier application is further configured to determine the quantity of potential buyers based on current financing status of a current vehicle possessed by the one or more potential buyers. In such embodiments of the apparatus, the potential buyer identifier application may be further configured to determine the quantity of potential buyers based on at least one of a current amount outstanding on a loan or lease of the current vehicle, a number of payments remaining on the loan or lease of the current vehicle, and historical payment data indicating timeliness of making payments for the current vehicle.

In yet other specific embodiments of the apparatus the potential buyer identifier application is further configured to determine the quantity of potential buyers based on non-vehicle related financial information associated with the potential buyers. In such embodiments of the apparatus, the potential buyer identifier application is further configured to determine the quantity of potential buyers based on at least one of current job status of the potential buyers, current salary/income of the potential buyers, current savings amounts of the potential buyer, and bankruptcy status of the potential buyers.

In still further specific embodiments of the apparatus, the potential buyer identification application is further configured to determine an identity for each of the potential buyers.

In other specific embodiments of the apparatus the trade-in vehicle amount is further configured to determine the trade-in vehicle amount, such that the trade-in vehicle amount reflects a price at which the vehicle dealer should be able to re-sell the trade-in vehicle. In similar specific embodiments of the apparatus, the trade-in vehicle amount is further configured to determine the trade-in vehicle amount, such that the trade-in vehicle amount reflects a recondition amount.

A method for determining or verifying a trade-in vehicle amount that a vehicle dealer may offer a customer having a trade-in vehicle defines third embodiments of the invention. The method includes identifying at least one of (1) the trade-in vehicle and (2) a proposed trade-in vehicle amount for the trade-in vehicle. The method further includes determining, by a computing device, a quantity of potential buyers for the trade-in vehicle. The potential buyers are determined based on information available to the vehicle dealer that relates to potential buyers who have a current vehicle that is similar in at least one respect to the trade-in vehicle. In addition, the method includes determining one of (1) a trade-in vehicle amount for the vehicle that may be offered to the customer based on the quantity of potential buyers, or (2) that the proposed trade-in vehicle amount may be offered to the customer having the trade-in vehicle based on the quantity of the potential buyers.

A computer program product including a non-transitory computer-readable medium defines fourth embodiments of the invention. The computer-readable medium includes computer-executable instructions to cause a computer to implement the steps of determine a quantity of potential buyers for an identified trade-in vehicle sought to be traded-in by a customer. The potential buyers are determined based on information available to the vehicle dealer that relates to potential buyers who have a current vehicle that is similar in at least one respect to the trade-in vehicle. The steps additionally include determine the trade-in vehicle amount that may be offered to the customer having the trade-in vehicle based on the quantity of the potential buyers.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a schematic/block diagram depiction of a system for generating targeted and customized vehicle offers, according to an embodiment of the present invention;

FIG. 2 is a schematic diagram of a system for generating targeted and customized vehicle offers highlighting the ability to communicate and access various different networked databases, according to another embodiment of the present invention;

FIG. 3 is a block diagram of a server/computing device including a customer identification module, in accordance with present embodiments;

FIG. 4 is a high level process flow diagram for generating targeted and customized potential vehicle proposals, in accordance with present embodiments;

FIG. 5 is a block diagram of a user interface configured for determining a trade-in vehicle amount based on a determined quantity of potential buyers for the trade-in vehicle; in accordance with embodiments of the present invention;

FIG. 6 is a flow diagram of a method for determining a trade-in vehicle amount based on a determined quantity of potential buyers for the trade-in vehicle; in accordance with embodiments of the present invention;

FIG. 7 is a flow diagram of method for verifying a trade-in vehicle amount based on a determined quantity of potential buyers for the trade-in vehicle; in accordance with embodiments of the present invention;

FIG. 8 is a block diagram of an exemplary User Interface (UI) for inputting data that identifies a group of prospective customers that may be targeted for vehicle offers, in accordance with present embodiments;

FIG. 9 is a block diagram of an exemplary prospective customer listing panel display, in accordance with an embodiment of the present invention;

FIG. 10 is a block diagram of an exemplary User Interface (UI) for selecting a proposed vehicle for sales offer and selecting the financial transaction parameters associated with the selected vehicle, in accordance with present embodiments;

FIG. 11 is a block diagram of an exemplary User Interface (UI) for selecting a proposed vehicle for lease offer and selecting the financial transaction parameters associated with the selected vehicle, in accordance with present embodiments;

FIG. 12 is a block of an exemplary User Interface (UI) for determining a prospective customer's vehicle equity, in accordance with present embodiments;

FIG. 13 is a block diagram of an exemplary retail/sales report that includes a proposed retail/sales offer for a designated prospective customer, in accordance with another embodiment of the present invention;

FIG. 14 is a block diagram of an exemplary lease report that includes a proposed lease offer for a designated prospective customer, in accordance with another embodiment of the present invention;

FIG. 15 is a block diagram of an exemplary equity report, in accordance with yet another embodiment of the invention;

FIG. 16 is a block diagram of an exemplary User Interface (UI) providing joint display of a sales/lease/equity report and prospective customer proposal communication mechanisms and history, in accordance with an embodiment;

FIG. 17 is a flow diagram of a method for generating targeted and customized vehicle offers for identified prospective customers, in accordance with an embodiment of the present invention;

FIG. 18 is a flow diagram of a method for determining the specifics of a sales offer, in accordance with an embodiment of the present invention; and

FIG. 19 is a flow diagram of a method for determining the specifics of a lease offer, in accordance with an embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Thus, methods, systems, computer programs and the like are herein disclosed that provide for a user, such as a vehicle dealership or a vehicle manufacturer, to identify a vehicle that is available to the user or that the user, or a dealership associated the user, would like to sell or lease. Once the vehicle is identified, prospective customers for the vehicle are identified based on information associated with existing/previous customers or prospective customers, such as customers who currently have a vehicle for which the identified vehicle is a likely substitute (i.e., same make and/or model or the like). Such information may include, vehicle service data, financing data related to the prospective customer's current vehicle, financial data/status of the prospective customer, location of the prospective customer, demographic data relating to the prospective customer and the like. Once one or more customers are identified, an action may be taken on behalf of the user. For the purposes of this invention, the term vehicles as used herein and as claimed refers to any conveyance that may require financing, such as, but not limited to, an automobile, a truck, a motorcycle, a recreational vehicle (RV), a mobile home, a boat, an airplane or the like, or further encompasses both new and previously-owned/leased vehicles.

While embodiments herein disclosed are discussed in terms of vehicles, the methods, systems, computer program products and the like may extend to other products, property and/or services, which utilize some form of financing and/or some re-occurring payment model. For example, the embodiments herein described may apply to real property, insurance policies, such as life insurance policies or the like.

Specific embodiments of the invention herein disclosed are operative to provide prospective customers with a potential vehicle proposal that is, in most instances, consistent with or better than their existing vehicle in a number of ways, including pre-existing financial obligation, in terms of monthly payments, equity or the like. Embodiments of the present invention include determining one or more potential vehicle proposals for a prospective customer based on assessing the current financial obligations associated with his/her current vehicle and choosing an appropriate vehicle to offer the prospective customer. Moreover, in today's volatile financial climate, the present invention allows for devising proposals that may decrease the prospective customer's financial obligations by decreasing their monthly payment but at the same time placing the prospective customer in a new vehicle, and in some instances, an upgraded make/model vehicle. Such a proposal may be devised by choosing a less expensive make/model than the prospective customers current vehicle, providing better finance rates than the current financial obligation, extending the finance term on the proposal or lowering the profit provided to the dealer in the proposal, or a combination of the forgoing. In other embodiments of the invention, once prospective customers are identified, the customers may be contacted about an identified vehicle in lieu of generating and communicating an actual potential vehicle proposal to the prospective customer.

Further embodiments of the invention provide for a manufacturer to access databases, such as affiliated dealership databases and/or financial institution databases (e.g., financing arms or the like), to determine customer vehicle data. Such dealership database information provides the manufacturer insight into the type of vehicles currently possessed by customers, such as make, model, trim line, options and the like, as well as, the age of the vehicle based on the model year. The financial institution database information provides the manufacturer insight into loan information related to customers, e.g., amount of loan outstanding, percentage of initial loan outstanding, late payment information and the like.

In addition to affiliated dealership databases and financial institution databases, the manufacturer may also have access to third-party databases or information that may pertain to making inventory related decisions. For example, demographic information on a country, region within a country, dealership or the like; economic indicators for a country or region with country; other manufacturer's current or upcoming sales promotions or incentives; information on natural disasters that may have affected the demand for vehicles in the area and the like.

Based on the information accessible to the manufacturer, the present invention can be implemented to determine what vehicles a manufacturer should build in the future to meet expected demand or identify potential customers to whom those vehicles should be targeted. Such determination may be made based on, for instances, singularly or in combination, like-to-like match (e.g., same make and model and in some instances, trim line and/or options) between the customer's vehicle and the vehicle(s) to be manufactured, the financing information indicating that a group of identified customers is likely to trade-in their current vehicle in the near future or any other information accessible to the manufacturer. The information on potential customers to target for the vehicles being manufactured may, in turn, be communicated to the affiliated dealerships that are in proximity to the potential customers.

In other embodiments of the invention, the information accessible to the manufacturer, such as customer information related to the customer's current vehicle (e.g., make, model, year, etc.), financing information associated with the current vehicle, and other customer related information (e.g., economic indicators for a country or region, weather or natural disaster information, etc.), is implemented to determine where to distribute currently existing or soon to be existing inventories of vehicles. For example, distribution in terms of specific countries, specific regions of a country, specific states, specific counties, specific cities, specific dealerships or the like. Such determination may be based on, singularly or in combination, like-to-like match (e.g., same make and model and in some instances, trim line and/or options) between the current vehicles of customers in a region and the vehicle(s) to be manufactured; the financial information indicating that the customer is likely to trade-in their current vehicle in the near future; and/or economic indicators in a region, demographic indicators in a region, current weather/disaster conditions in a region and/or the like.

In still further related embodiments of the invention, the information accessible to the manufacturer, such as customer information related to the customer's current vehicle (e.g., make, model, year, etc.), financing information associated with the current vehicle, and other customer related factor information (e.g., economic indicators for a country or region, weather or natural disaster information), is implemented to determine what vehicles to apply sales incentives to and the optimal amount or structuring of the incentives. For example, if use of the invention indicates a surplus of a particular vehicle due to minimal potential buyers for that vehicle, as indicated by a limited number of customers are interested in the vehicle or other relevant data indicates may purchase such a vehicle, the manufacturer is better able to determine that vehicle should have incentives applied to it based on foreseen low demand for the vehicle. Moreover, based on the level of the surplus, a determination can be made as to the optimal amount or the structuring of the incentive program.

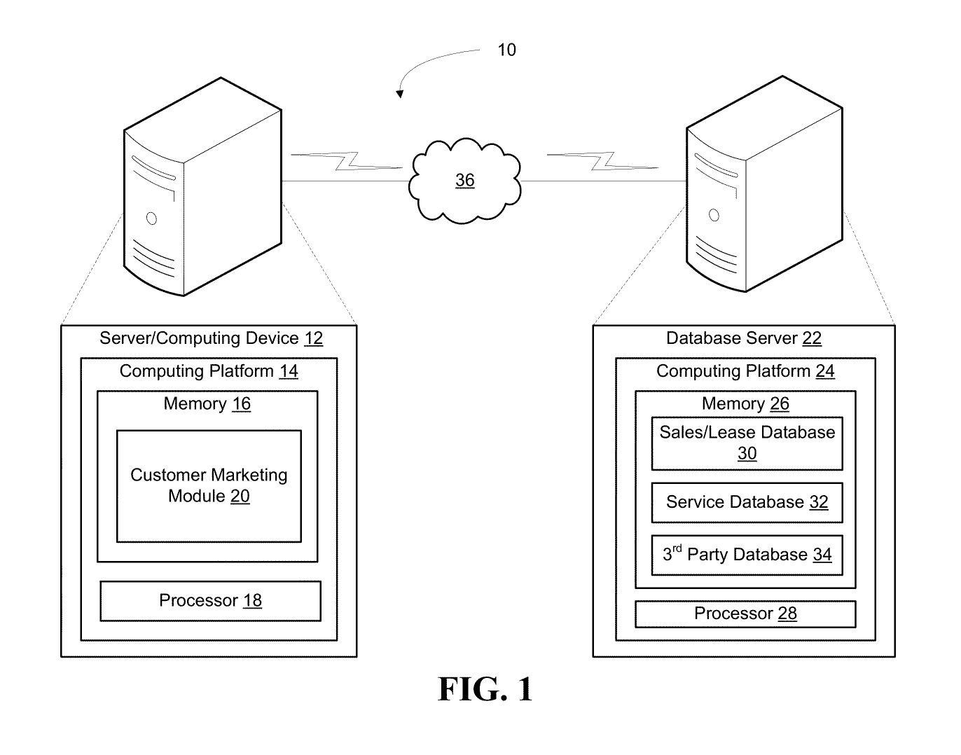

Referring to FIG. 1, a high-level schematic/block diagram is depicted of system for identifying a vehicle accessible to a user and, once the vehicle is identified, identifying prospective customers for the vehicle based on information specific to the prospective customer, in accordance with embodiments of the present invention. The system 10 comprises a server/computing device 12, which may be a dedicated server computer or a desktop/laptop computer implementing a server application, such as SQL (Structured Query Language) server express 2005 or greater, available from the Microsoft Corporation of Redmond, Wash. As such, server/computing device 12 includes a computer platform 14 that includes memory 16 and a processor 18 in communication with memory 16. The memory 16 stores, and the processor 18 is configured to operate, customer identification module 20.

Customer identification module 20 is operable to identify one or more prospective customers for an identified vehicle based on their current vehicle type, current vehicle mileage, current vehicle age, ongoing financial obligations associated with the current vehicle, other customer related information, such as demographics data, location data and/or variable parameters associated with a vehicle transaction proposal. In addition, the invention provides for the user to identify a proposed vehicle for the one or more prospective customers by either choosing a proposed vehicle from a listing of available vehicles or defining vehicle parameters for a proposed vehicle.

Once a proposed vehicle is identified, variable parameters associated with a proposed vehicle offer are set. For potential sales terms, these variable parameters may include, but are not limited to, vehicle parameters, such as, a sales price, a finance rate, a finance term, a minimum user/seller, such as a dealer, profit and a user/seller, such as a dealer, incentive; and prospective customer parameters, such as variance of the monthly payment above the current payment and minimum equity in the current vehicle. For a potential lease terms, these variable parameters may include, but are not limited to, vehicle parameters such as, a minimum lease profit, a user incentive, a cap cost reduction, a residual percentage and a money factor; and prospective customer parameters such as variance of the monthly payment above the current payment.

Once the vehicle is identified, prospective customers are identified, and proposal variable parameters are set, proposed terms for the identified vehicle may be determined. Determination of the proposal includes determining an estimated market value of the customer's current vehicle. Additionally, determination of a sales proposal may include, but is not limited to, determining an estimated current vehicle payoff amount, determining estimated sales tax, determining an estimated net cap cost for the proposed vehicle and determining an estimated monthly payment for the proposed vehicle. For potential lease terms, the proposal determination may include, but is not limited to, determining an estimated monthly finance charge, determining a proposed finance charge, determining estimated total taxes, determining an estimated monthly depreciation charge and determining and setting a lease turn-in alert. It should be noted that in other embodiments of the invention other relevant information is identified, such as customer-specific advertisements or the like, for subsequent electronic communication to the customer. In such embodiments it may not be necessary to determine a proposal for the prospective customers.

Once the proposals or other relevant information for each prospective customer are determined, the module 20 may generate an internal report for the user that includes customer information, current customer vehicle information, a proposed terms for the identified vehicle, identification of a vehicle meeting the customer's needs, identification of vehicle requirements and the like. The internal report may be disseminated to a designated email distribution list within the user organization and the information in the report used for review of other additional internal functions, manual or automated. In addition, the module may also generate and initiate the communication of customer email, texts, voice mail or the like that provides some form of communication, including in some instances the proposed terms for the vehicle that are communicated to the customer and/or a letter generating routine that provides similar types of communications.

In addition to server/computing device 12, system 10 includes database server 22. While a single server is shown in FIG. 1, in practice the database server 22 may comprise more than one server. Server 22 includes a computing platform 24 having a memory 26 and a processor 28 in communication with the memory. The memory 26 stores, and the processor is configured to access, sales/lease database 30 and/or service database 32 and/or third-party database 34, such as a financial institution databases or the like. Sales/lease database 30 and service database 32 may be internal, dealership-based databases or external databases. External databases may include, but are not limited to, Automatic Data Processing (ADP) dealer services database, Reynolds & Reynolds database or the like. Thus, the network 36 communication link between the server/computing device 12 that includes the customer identification module 20 and the database server 22 may be a local network, an external network, such as the Internet or a combination of a local network and an external network. To facilitate the exchange of data between the system and the internal databases, the system may be in continual connection with such databases to insure up-to-date data or, alternatively, the system may periodically upload data from such databases.

The sales/lease database 30 may be accessed by customer identification module 20 to retrieve information related to previous customer sales or leases such as previous customer's current vehicle type and ongoing financial obligations associated with the current vehicle. This type of information is used to define the group of prospective customers for whom a report will be returned.

The service database 32 may be accessed to identify one or more prospective customers based on a pending or previous service appointment. Additionally, service database 32 may be accessed by customer identification module 20 to retrieve information related to previous service information, such as vehicle type, service history and the like. This type of information may also be used to define the group of prospective customers for whom a report will be returned. Additionally, service database 32 may be accessed by customer identification module 20 to retrieve information associated with the present condition of the customer's current vehicle, which may be used in determining the terms which are used to determine an estimated market value of the current vehicle. For example, the service database 32 may indicate a most recent mileage reading for the current vehicle.

The third-party database 34, such as financial institution database or the like may be accessed by customer identification module 20 to retrieve information related to previous or ongoing financial transactions, such as ongoing loans or the like financed through the financial institution. In addition to identifying prospective customers based on the previous/ongoing financial transactions, the third-party database can provide other information, such as FICO scores, loan payoff information, past due or late payment information and the like.

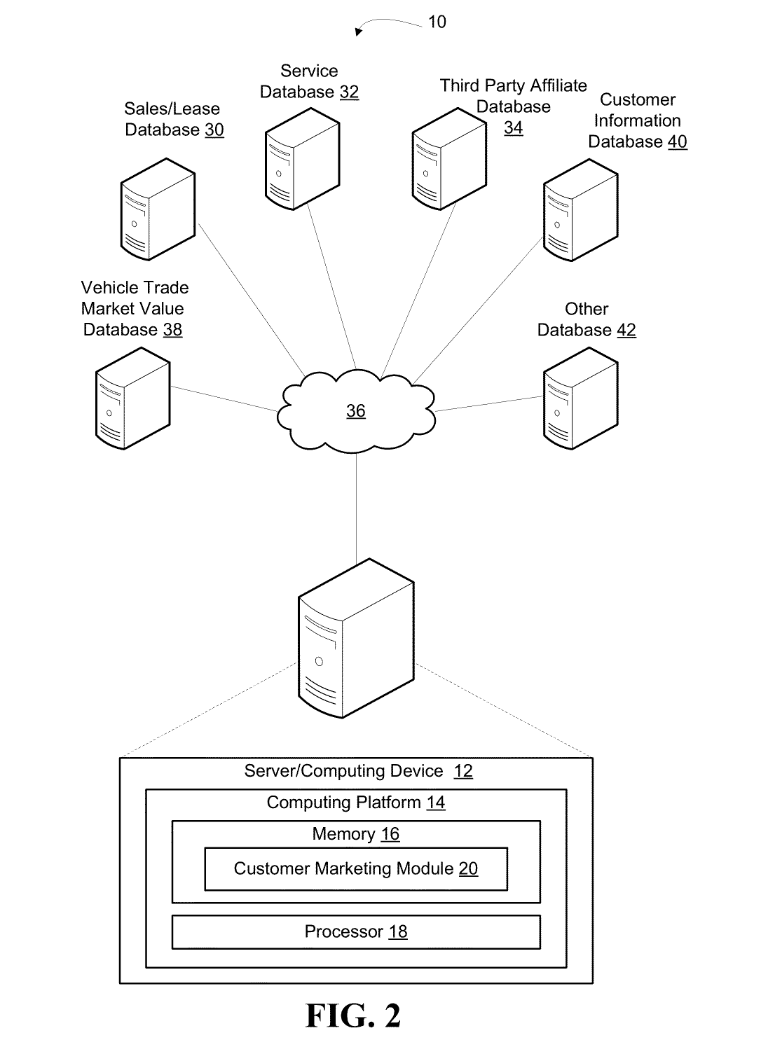

Referring to FIG. 2, a schematic/block diagram is provided that illustrates various databases which may be included in system 10, according to present embodiments of the invention. In addition to sales/lease database 30, service database 32, and third-party database 34, the customer identification module 20 may be in communication with and access other databases, such as vehicle trade-in market value database 38, customer information database 40 or any other database 42 that provides for public or private access. Customer identification module 20 may access vehicle trade-in market value database 38 to determine the current trade-in value for the prospective customer's current vehicle. Examples of vehicle trade-in market value databases 38 include, but are not limited to, BlackBook®, CarFax® or the like. As previously noted, the customer identification module 20 may access a service database 32 to retrieve information that is obtained as part of the dealer servicing the customer's existing vehicle that reflects the present condition of the current vehicle, such as a current mileage reading, which may be used during the proposal determination process to determine an estimated market value of the customer's or group of customers current vehicle. In addition, the customer identification module 20 may provide for the dealer/user to define a book-value-to-use parameter, such as wholesale average or the like.

The customer information database 40 may include any database that provides contact type information for the customer, such as current address, current phone numbers, current email addresses and the like. The customer identification module 20 may access customer information database 40 to verify that customer information found in an internal sales/lease database is up-to-date and accurate and provide updated contact information where needed. An example of a customer information database 38 includes, but is not limited to, Whitepages.com™ or the like.

Other databases 42 currently accessible or accessible in the future may also be accessed and implemented in conjunction with the customer identification module 20. The other databases 42 may include any database that includes further customer information or customer demographic information that may be used by the customer identification module 20 to determine the group of prospective customers which are suitable for an identified vehicle. For example, other database 42 may include a credit reporting database that may be accessed to estimate the current financial status of prospective customers. Examples of credit reporting databases include Equifax®, Experian®, TransUnion® and the like. Additionally, other databases 42 may include a lender database, a census database, a tax database or any other government registration database, such as a state or county vehicle registration database. Such databases may be accessed to determine prospective customers that are new to the geographic area or the like. Additionally, other databases 42 may include a map database, such as Google® map, Microsoft® MapPoint® or the like, that are accessible by the customer identification module 20 to generate maps that indicate the address/physical location of prospective customers identified in the proposal process. Also, any other database that may provide insight into the customer's current financial status may also be beneficial to determining the group of prospective customers. For example, a government database that indicates a claim for employment benefits may be beneficial to identifying a prospective customer group for an identified vehicle that may be interested in potential vehicle proposals that would take them out from under an existing financial obligation and place them in a vehicle with a new financial obligation less than their current obligation, e.g., lower monthly payments.

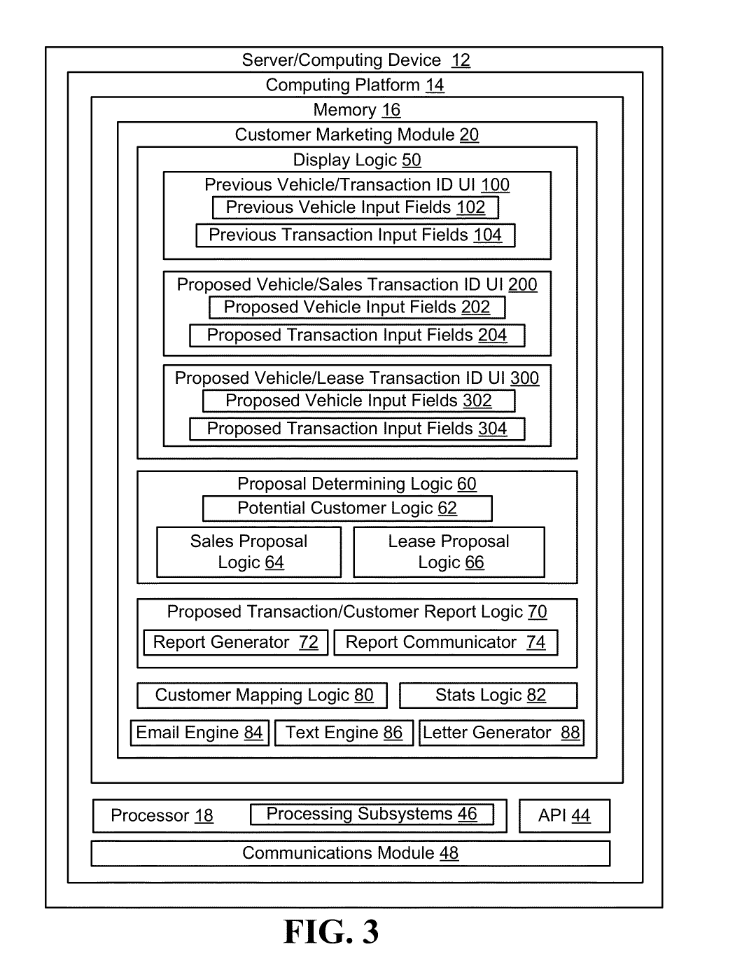

Turning the reader's attention to FIG. 3, a block diagram is depicted of a server/computing device 12 that includes the customer identification module 20, according to the present embodiment of the invention. In addition to providing greater detail, FIG. 3 highlights various optional embodiments. The server/computing device 12 may include any type and/or combination of one or more computing devices, such as a personal computer, a laptop/portable computer, a wireless or handheld computing device, a personal digital assistant (PDA), a server or the like. The computer platform 14 is operable to receive and execute modules, routines and applications, such as customer identification module 20 and the like. Computer platform 14 includes memory 16, which may comprise volatile and nonvolatile memory such as read-only and/or random-access memory (RAM and ROM), EPROM, EEPROM, flash cards, or any memory common to computer platforms. Further, memory 16 may include one or more flash memory cells, or may be any secondary or tertiary storage device, such as magnetic media, optical media, tape, or soft or hard disk.

Further, computer platform 14 also includes processor 18, which may be an application-specific integrated circuit (“ASIC”), or other chipset, processor, logic circuit, or other data processing device. Processor 18 or other processor such as ASIC may execute an application programming interface (“API”) layer 44 that interfaces with any resident programs, such as customer identification module 20 or the like, stored in the memory 16 of server/computing device 12.

Processor 18 includes various processing subsystems 46 embodied in hardware, firmware, software, and combinations thereof, that enable the functionality of server/computing device 12 and the operability of the device on a network. For example, processing subsystems 46 allow for initiating and maintaining communications and exchanging data with other networked devices.

Additionally, computing platform 14 includes a communication module 48 embodied in hardware, firmware, software, and combinations thereof, that enables communications among the various components of the server/computing device 12, as well as between the network 36. In described aspects, the communication module 48 enables the wired and/or wireless communication of all correspondence between server/computing device 12 and other wired or wireless devices. Thus, communication module 12 may include the requisite hardware, firmware, software and/or combinations thereof for establishing a wireless network communication connection.

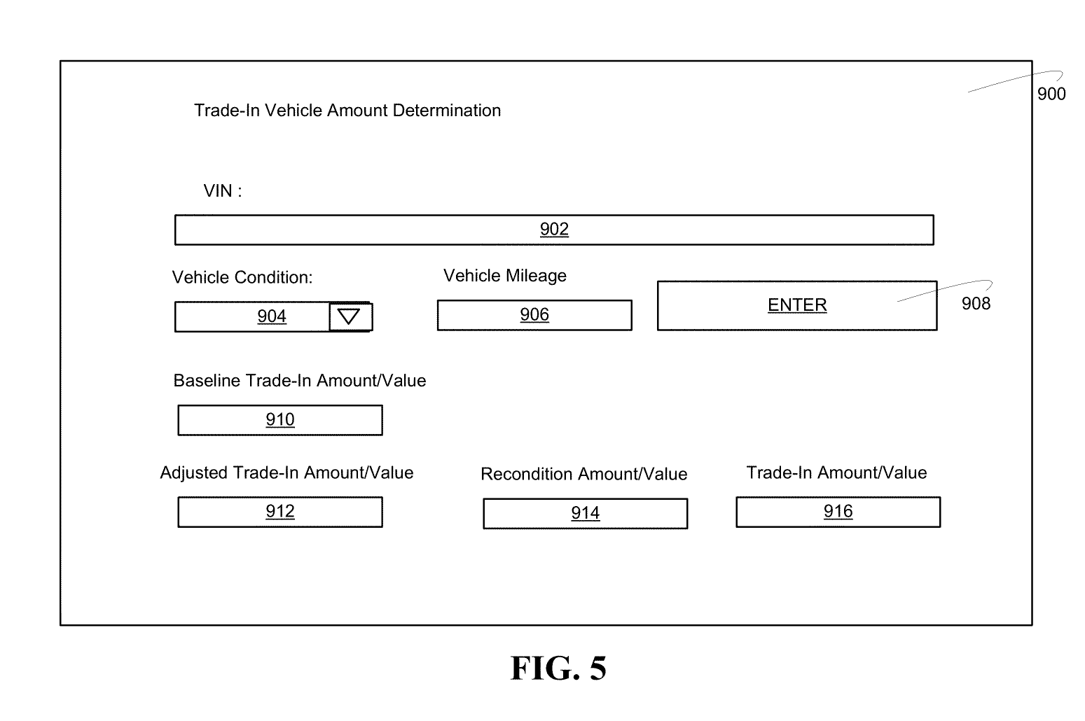

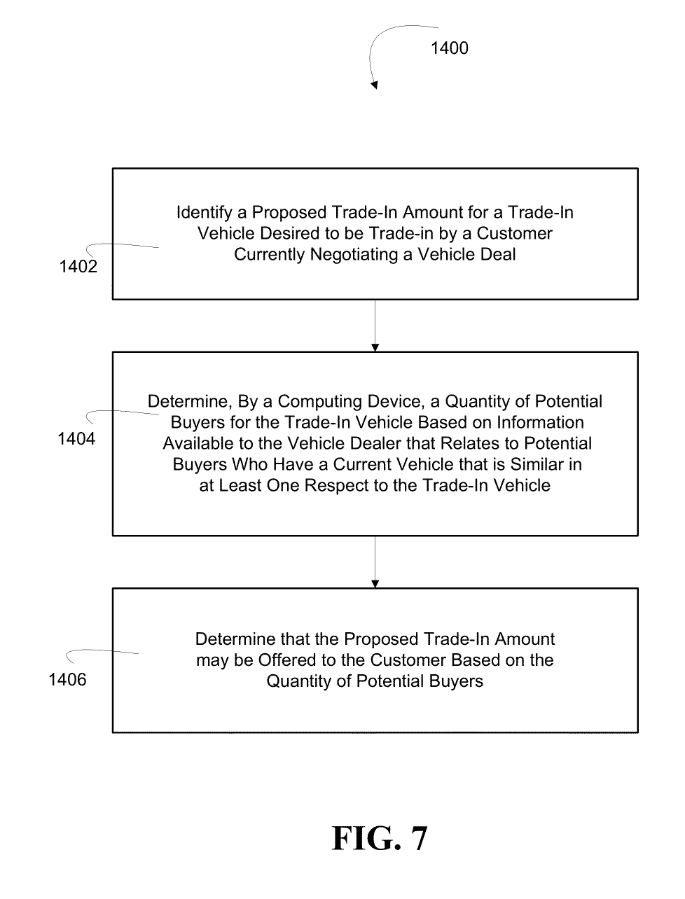

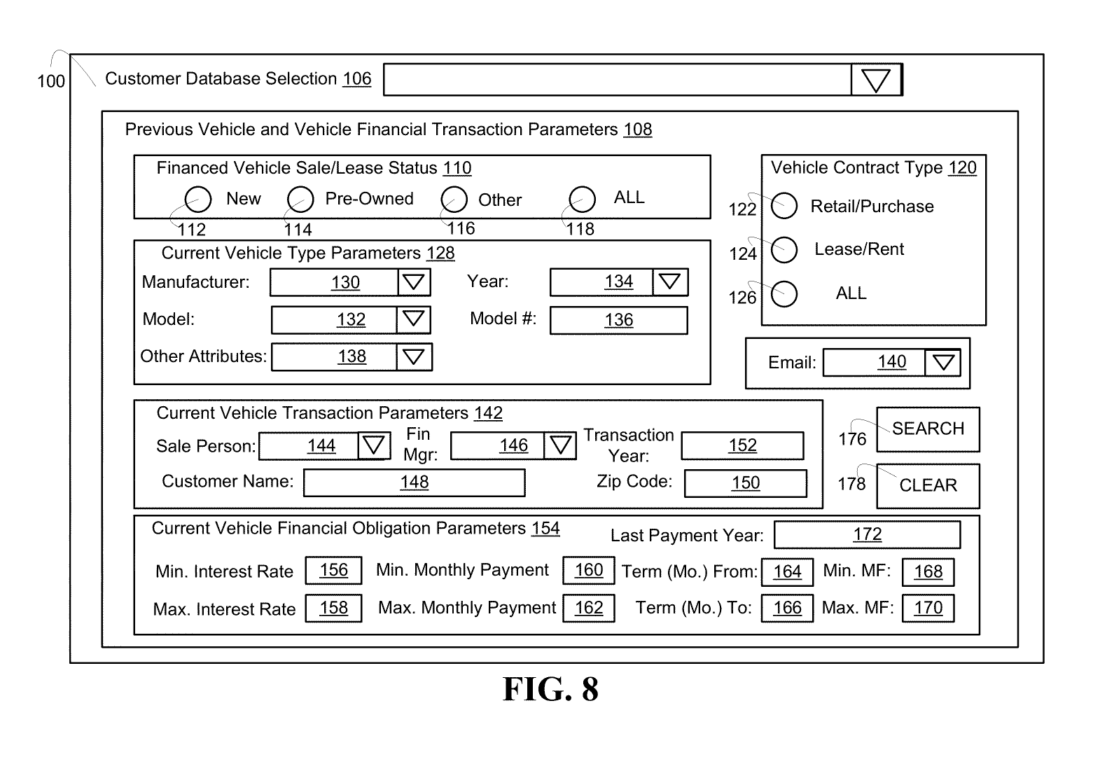

The memory 16 of server/computing device 12 stores customer identification module 20. Customer identification module 20 includes display logic 50 that is operable for displaying User Interfaces (UIs), such as previous vehicle/transaction identifying UI 100 (shown and described in FIG. 5), proposed vehicle/sales transaction identifying UI 300 (shown and described in FIG. 7) and proposed vehicle/lease transaction identifying UI 600 (shown and described in FIG. 8).

UI 100 may include a plurality of previous vehicle parameter input fields 102, which define the type of vehicle that prospective customers currently own/finance, such as input fields for make, model, year and the like. UI 100 may also include a plurality of previous vehicle transaction input fields 104, which define attributes/parameters associated with the financial obligation (i.e., loan or lease) pertaining to the customer's current vehicle. Inputs into input fields 102 and 104 are implemented as search criteria for identifying prospective customers from an internal or external customer database. The identified prospective customers may be identified based on match between a characteristic associated with the customer and an identified vehicle, such as the customer's current vehicle being a same make and model as the identified vehicle. In addition, other vehicle parameter input fields 102 not shown nor described may exist that include other relevant information.

UI 200 may include a plurality of proposed vehicle parameter input fields 202, which define the vehicle that is being proposed for sale by the user to the subsequently identified prospective customer(s), such as input fields for make, model, year and the like. Or the UI may allow for the user to select the vehicle from a list of available vehicles. UI 200 may also include a plurality of proposed vehicle transaction input fields 204, which define attributes/parameters associated with the proposed financial loan pertaining to the proposed vehicle. Inputs into input fields 202 and 204 are subsequently used in determining the specifics of the sales proposal that may be presented to the prospective customers.

UI 300 may include a plurality of proposed vehicle parameter input fields 302, which define the type of vehicle that is being proposed for by the user to the subsequently identified prospective customer(s), such as input fields for make, model, year and the like. Or the UI may allow for the user to select the vehicle from a list of available vehicles. UI 300 may also include a plurality of proposed vehicle transaction input fields 304, which define attributes/parameters associated with the proposed lease pertaining to the proposed vehicle. Inputs into input fields 302 and 304 are subsequently used in determining the specifics of the potential lease terms that may be presented to the prospective customer.

Customer identification module 20 also includes proposal determining logic 60 that is operable to determine sales or potential lease terms for the identified prospective customers and the identified proposed vehicles based on the inputs received at UIs 100, 200, 300. In this regard, proposal determining logic 60 may include prospective customer logic 62 operable for determining a group of prospective customers from an internal or external database of customers based on inputs at UI 100, such as inputs related to an identified vehicle. Proposal determination logic 60 may additionally include sales proposal logic 64 operable for determining specific attributes of a sales proposal based on inputs at UI 200. Additionally, proposal determination logic 60 may additionally include potential lease terms logic 66 operable for determining specific attributes of a potential lease terms based on inputs at UI 300.

Customer identification module 20 may also include proposed transaction reporting logic 70 operable to generate and communicate a proposed sales or proposed lease report that details the targeted and customized sales or potential lease terms. In this regard, proposed transaction reporting logic 70 may include proposed sales/lease report generator 72 operable to generate the sales and/or lease reports and proposed sales/lease report communicator 74 operable to communicate the reports electronically to a plurality of designated recipients, such as sales associates.

The customer identification module 20 may also include mapping demographic logic 80 operable to connect with external map databases, such as Google® Maps or the like to retrieve maps and produce maps with customer demographics data, such as location of customers and the like.

In further embodiments, the customer identification module 20 may also include statistics logic 82 operable to determine statistical data related to previous sales/leases and/or currently proposed sales/leases and/or service-related data. The statistics logic 82 may generate statistics that are displayable through display logic 50 and/or communicable via email engine 84, text engine 86 or the like. Statistical data related to previous sales/leases may include, but is not limited to, sales/leases per month of a vehicle type, sales per loan maturity year, leases per lease maturity year, sales/leases per geographical area, and the like. Statistical data related to service-related data may include, but is not limited to, quantity serviced per vehicle type, quantity of proposed sales/potential lease terms per serviced vehicle type, quantity of pending service appointments per date, quantity of proposed sales/potential lease terms per date, quantity of vehicles with no service history, quantity and vehicle type of vehicles serviced with no sales history and the like.

Additionally, the customer identification module 20 may also include an email engine 84 and/or text engine 86 that is operable for generating internal email/texts and external email/texts associated with the customer identification module 20. Examples of internal email/texts may include email/texts that include the sales or lease reports and email/texts that include sales related task lists associated with the sales or lease reports, such as contact responsibilities and the like to be carried out by sales associates or management at the dealership. Examples of external emails/texts may include customer emails/texts directed to create interest by the customer in the vehicle identified by the user, including customized sales or potential lease terms. Further examples include third-party affiliate emails/texts, such as those communicated to a financial institution/lender, that notifies the third-party of the identified targeted and customized sales or potential lease terms. In the third-party affiliate scenario, the information provided to the third-party affiliate may be used to provide communications to the prospective customers via third-party affiliate advertising, such as bank/loan statement advertising or the like. Customer identification module 20 may additionally include letter generator/editor 88 that is operable to create and edit customer letters which are to be communicated to a prospective client according to predetermined guidelines.

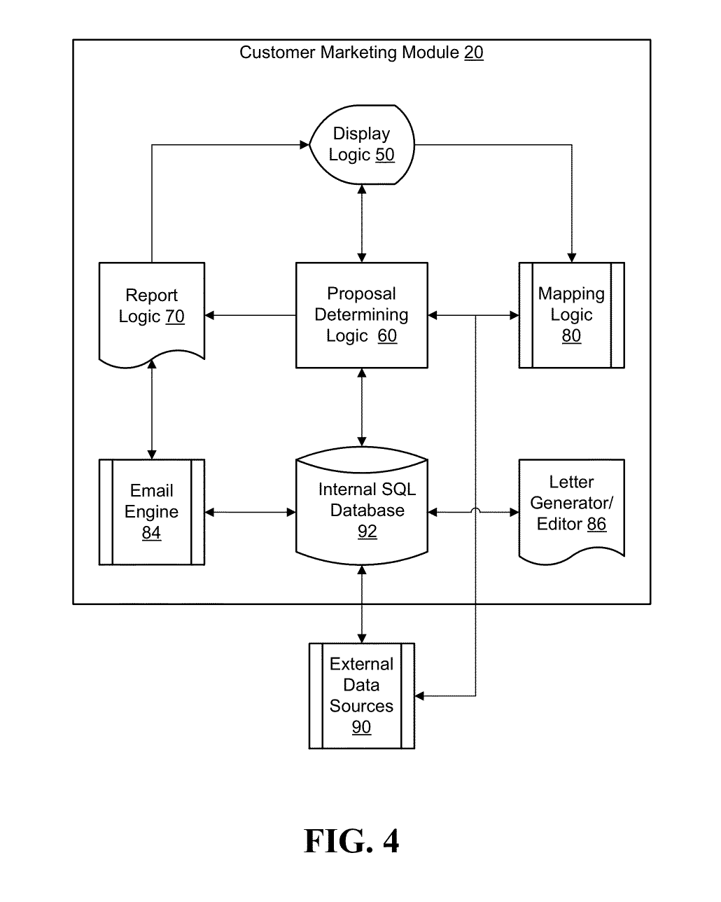

FIG. 4 depicts a high level process flow between the various components of the customer identification module 20 and external data sources 90; in accordance with an embodiment of the present invention. Display logic 50 is operable to display UIs that receive user inputs for identifying a proposed vehicle for sale or lease and identifying prospective customers for the identified vehicle based on current vehicle type and/or current financial obligations associated with the current vehicle and the parameters associated with a financial transaction (i.e., lease or loan) pertaining to the proposed vehicle. Display logic 50 is in communication with proposal determining logic 60, which receives the user inputs and determines prospective customers and the specifics of the sales and or potential lease terms offered to the prospective customers.

Display logic 50 is also in communication with report logic 70 and mapping demographic logic 80. Report logic 70 is operable to receive potential proposals from proposal determination logic 60 and generate sales and/or lease reports that include based on the determined proposals. The reports may be displayed via display logic 50 or the reports may be communicated electronically via email engine 84 to sales associates or the like. Mapping demographics logic 80 is operable to create maps that include prospective customer demographic data, such as the location of certain groups of customers and corresponding contact information. Mapping logic 80 relies on generic map templates for creating the maps and, as such, is in communication with external data sources 90, such as Google® maps or the like for accessing and retrieving map templates. The maps generated by mapping demographics logic 80 are operable to be displayed via display logic 50.

Proposal determining logic 60 is in communication with internal Structured Query Language (SQL) database 92 that is operable to sort and manipulate data for communication between all of the logic entities of the customer identification module 20 and the external data sources 90. The customer identification module 20 also includes letter generator/editor 86 in communication with the internal SQL database and operable to generate customer letters based on letter templates and proposed sales or potential lease terms communicated from the proposal determination logic.

In accordance with other embodiments of the invention, methods systems and computer program products are defined that provide for determining a vehicle trade-in amount that can be offered to a vehicle buying/leasing customer based on an automated determination of the number and, in some embodiments, identity of potential buyers for the vehicle being traded-in. In specific embodiments of the invention, the number of potential buyers for the vehicle being traded-in may be determined while the customer seeking a trade-in is at the vehicle dealership or while the customer is otherwise in active negotiation to purchase or lease another vehicle (e.g., negotiating via an online chat, email, text or the like). Such insight into the number of potential buyers of the vehicle being traded-in allows the users to more accurately determine a vehicle trade-in amount and, in many instances, provides for the user to offer the vehicle buying/leasing customer a higher trade-in amount than they would otherwise be afforded at that dealership or in the marketplace. In some embodiments, the determination of the number of potential buyers may result in a best or highest available trade-in amount.

In a typical vehicle buying or leasing deal the customer will present a vehicle for trade-in. Since the customer seeks the highest amount possible on their trade-in vehicle, often the ability to close the deal will hinge on the amount that the vehicle seller is able to give the customer for their trade-in vehicle. Conventionally, the baseline trade-in value is determined based on a “book” value, such as a Kelly Blue Book value or the like, which takes into account the vehicle make, model, trim line, options, mileage, condition and the like. A dealership or other vehicle selling entity is able to increase, or in some instances decrease, this amount based on its perceived ability to sell the vehicle at their dealership within a certain time period, for example, within thirty to ninety days, and sell the vehicle for a certain desired amount. Thus, for the purposes of this invention the vehicle trade-in amount is the baseline trade-in value adjusted by the additional trade-in amount and, in some embodiments, offset-set by the recondition value (i.e., the cost associated with preparing the trade-in vehicle for re-sale). A key indicator in determining whether the dealership will be able to sell the vehicle at their dealership within the time period and/or for a desired amount, is the number of potential buyers that a dealership may be able to identify, target and offer the vehicle for sale or lease. Historical data has shown that the more potential buyers that exist the faster the vehicle is likely to sell and for a price that is desired by the dealership. If such indications of a timely sale for a desired price are evident, the dealership is in a better position to offer the customer additional amounts for their trade-in vehicle above the baseline trade-in value.

In accordance with specific embodiments of the invention, the dealership or other vehicle selling/leasing entity may authorize an additional trade-in amount (for example, an amount desired by the vehicle buying/leasing customer above the baseline trade-in value) or, in other embodiments determine an additional trade-in amount for the vehicle as a result of determining the quantity, and in some embodiments, identity of potential buyers for the vehicle being traded-in.

To further accelerate the trade-in amount authorization/determination process the dealership may scan or otherwise capture/input the Vehicle Identification Number (VIN) from the vehicle and input the current vehicle mileage and condition into a potential buyer identifier application. Such information is used to assess and determine the baseline trade-in amount of the vehicle. In addition, such information is used to identify the number and, in some instances, identity of potential buyers for the vehicle being traded-in. In addition, the potential buyer identifier application may be configured to receive a user input that defines the desired trade-in amount above the baseline trade-in amount that is authorized or, in other embodiments, a trade-in vehicle amount determination application may be configured to determine the additional trade-in amount, typically a maximum amount, above the baseline trade-in amount that the dealership can offer the vehicle buying/leasing customer for their trade-in vehicle.

In specific embodiments, determining the number and, in some embodiments, identity of potential buyers may include accessing the dealership's database of previous customers and determining which customers have a similar, or same, make and model vehicle to the vehicle being traded-in and a same or earlier model year vehicle as the trade-in vehicle. In specific embodiments the determination may further include determining which of the dealer's customers have vehicles with similar, or the same, trim lines or options, etc., to further identify a smaller group of potential buyers for the trade-in vehicle. In addition, in specific embodiments, the determination may include which customers have a vehicle that is higher in current mileage than the trade-in vehicle. Current mileage of the potential buyer's vehicle may be estimated or otherwise determined based on vehicle mileage maintenance records (i.e., the current mileage may be estimated based on one or more of the date of the last maintenance, the mileage at the last maintenance and/or the average yearly or monthly mileage that the customer drives the vehicle, as may be determined from the mileage indicated in the maintenance records).

In further embodiments of the invention, the quantity and, in some embodiments, identity of potential buyers for the trade-in may further be determined based on current financing status of the potential buyers. For example, in instances in which the dealership has access to customer financing status data, either internally or through third-party reporting entities, such as a financial institution or financing arms, the current amount outstanding on the loan or lease, the number of payments remaining on the loan or lease, the timeliness of making payments and the like, may be used as a basis for determining potential buyers of the trade-in vehicle. Additionally, the number and, in some embodiments, identity of potential buyers may further be determined based on other financial information (non-vehicle related financial information) provided by third-party reporting entities, such as the current job status of the potential buyers, the current salary/income of the potential buyers, current savings of the potential buyer, bankruptcy status of the potential buyers and the like. Moreover, the number and identity of potential buyers may further be determined or refined based on non-financial information related to the potential buyers. Such information may be accessible internally (e.g., previous customer database) or through third-party reporting entities. Non-financial information may include, but is not limited to; the proximity of the potential buyer to the dealership (based on current residence or workplace), potential buyer demographics (e.g., area code, zip code, county/state and the like), information related to how often the potential buyer buys or leases a vehicle, and the like. In addition, non-financial information may include social media-related information or the like which indicates the potential buyers current desire to buy/lease another vehicle and, specifically, buy or lease a vehicle of the make and/or model of the trade-in vehicle.

In specific embodiments of the invention the pool of potential buyers for the trade-in vehicle will be drawn from the dealership's customer database. In those embodiments in which the dealership is affiliated or otherwise networked with a plurality of dealerships the customer database used in determining potential buyers may include all or a portion of the dealerships in the affiliated network. In other embodiments of the invention, the dealership may not be limited to determining potential buyers from the dealership database and/or the network of dealership database. In such embodiments, the dealership may have access, through a third-party entity or the like, to all or a portion of the potential buyers in the geographic region of the dealership or all or a portion of the potential buyers that meet other potential buyer defining criteria, even though the dealership (or the networked dealerships) has had no prior relationship (i.e., buyer-seller/leaser) with the potential buyer.

In those embodiments in which the additional trade-in amount is being verified/authorized (e.g., an amount desired by the vehicle buying/leasing customer above the baseline trade-in value), the identification of the quantity and, optionally, identity of potential buyers may be manually or, in some embodiments, heuristically by a computing device, compared to the desired additional amount above the baseline trade-in value and a decision may be made as to whether the additional amount can be authorized. Such a decision allows for the user to take into account other criteria in determining whether the additional trade-in amount is justified, such as offsetting the actual amount offered to the customer based on the recondition value (i.e., the amount the dealer must pay to prepare the vehicle for re-sale).

In other embodiments of the invention in which the additional trade-in amount is being verified/authorized (e.g., an amount desired by the vehicle buying/leasing customer above the baseline trade-in value), a threshold number of potential buyers must be identified in order to offer the customer with a trade-in their desired additional trade-in amount, above the baseline trade-in amount. For example, if the additional desired trade-in amount is $500, the application(s) may be configured such that five or more potential buyers must be determined or, if the additional desired trade-in amount is $1000, the application(s) may be configured such that ten or more potential buyers must be identified in order for such an additional trade-in amount to be authorized.

In those embodiments in which a trade-in amount above the baseline trade-in amount is being determined each potential buyer identified may be associated with an amount (in some embodiments, up to a maximum amount) or a range of potential buyers may define the trade-in amount. For example, each potential buyer may equate to a $100 additional trade-in amount, such that, if seven potential buyers are identified, the user (e.g., dealership or the like) may offer the customer up to, but not exceeding, an additional $700 in trade-in amount. In another example, a range of three to five potential buyers may allow the user to offer the customer up to, but not exceeding, an additional $500 in trade-in amount, a range of six to ten potential buyers may allow the user to offer the customer up to, but not exceeding, an additional $1,000 in trade-in amount and so forth. It should be noted that identification of no potential buyers (e.g., based on a failure to determine make and model matches or the like) may result in no additional trade-in amount above the baseline trade-in amount or, in some embodiments, a decrease in the baseline amount offered to the customer for their trade-in.

In addition to authorizing or determining a trade-in amount based on the number of potential buyers, the trade-in vehicle amount determination application may further determine the additional trade-in amount based on other factors related to the vehicle that is being traded-in. For example, the application may offset the combined baseline trade-in value and additional trade-in amount by a recondition value (i.e., the amount required to prepare the trade-in vehicle for re-sale). The recondition value may vary based on the condition of the trade-in vehicle, features specific to the trade-in vehicle and the like. Additionally, the application may take into account the dealerships current inventory of vehicles having a similar or same vehicle type (e.g., sedan, sport, SUV, van) as the vehicle being traded-in. Or in further embodiments, the application may take into account the dealerships current inventory or readily available access to vehicles having a similar or same make, model, year, trim line and/or options as the vehicle being trade-in. In this regard, a surplus of like type and/or make/model vehicles in current inventory may result in determination of a lower trade-in amount that can be offered to the customer or may increase the threshold number of prospective customers. Conversely, a current shortfall of like type and/or make/model vehicles in current inventory may result in determination of a higher trade-in amount that can be offered to the customer or may decrease the threshold number of potential buyers. In additional embodiments of the invention, the application may have access to information related to other dealerships in the geographic area of the dealership, such that the application can take into account the current inventory of vehicles in the geographic having a similar or same vehicle type (e.g., sedan, sport, SUV, van) as the vehicle being traded-in or vehicles having a similar or same make, model, year, trim line and/or options as the vehicle being trade-in. In additional embodiments, the trade-in vehicle amount determination application, in determining the additional trade-in amount, may take into historical data related to what amount the user, or in some embodiments other dealers in the geographic area of the user, typically resells vehicles similar to the vehicle being traded-in.

Further, the trade-in vehicle amount determination application may take into account the “desirability” of the vehicle being traded-in, where desirability is reflected by the current market demand for the trade-in vehicle, which may in certain embodiments be quantified by recent historical data related to average time to resell similar vehicles based on one or more of vehicle type and/or make, model, trim line, options etc., and average resell amount based on similar vehicles. The more “desirable” the vehicle being traded-in is the higher the trade-in amount that the dealer can offer to the customer, or, in some embodiments, a resulting decrease in the threshold number of potential buyers needed to authorize the higher additional trade-in amount. Conversely, if the vehicle is less “desirable” the lower the trade-in amount that the dealer can offer to the customer or, in some embodiments, the quantity in the threshold number of potential buyers needed to authorize the higher additional trade-in amount may increase.

In still other embodiments other data may be used in determining or authorizing the trade-in amount including, but not limited to, current economic indicators (unemployment indicators, stock market conditions, etc.), current time of year/time of month, new vehicle versus pre-owned sales statistics, new vehicle sales incentives, promotions offered by competitive dealers and the like. It should be noted that according to specific embodiments, if the application relies on other information indicative of value of the vehicle or the ability to resell the vehicle that is being traded-in to determine or authorize a trade-in amount, (or additional information in determining potential buyers), such information should be accessible to the user, through direct data feeds or the like, so that the user can determine the number and, in some embodiments, identity of potential buyers and such that the trade-in amount can be authorized or determined while the customer is at the dealership negotiating the deal or otherwise actively negotiating the deal (e.g., online negotiation though a chat session, email, text or the like).

Referring to FIG. 5, an example of a trade-in vehicle amount determination user interface 900 is shown, in accordance with embodiments of the present invention. The user interface 900 includes a Vehicle Identification Number (VIN) input 902 for a user, such as a vehicle dealer representative or the like, to enter the VIN associated with the trade-in vehicle. Additionally, the user interface 900 may include a vehicle condition input 904, which may be configured as a drop-down menu, for user input or selection of the condition of the trade-in vehicle. Also, the user interface may include a vehicle mileage input 906 for user input of the mileage of the trade-in vehicle. Once the VIN and, in some embodiment the vehicle condition and/or mileage, have been entered, a user engages the start key 908 to determine the baseline trade-in amount value, which is subsequently displayed in block 910. The baseline trade-in value is a conventional trade-in value, such as Blue Book® or other third-party entity-determined baseline trade-in value for the vehicle associated with the inputted data.

Once the baseline trade-in value is determined, the user/vehicle dealer representative may adjust the trade-in amount that may be offered to the customer. The user engages start key 908 to determine and display in block 916 the adjusted trade-in amount/value, which will typically be an additional amount above the baseline trade-in amount. In other embodiments of the user only needs to engage the start key 908 once to determine and display the baseline trade-in value and the adjusted trade-in amount/value. The adjusted trade-in value is determined based at least on the quantity of potential buyers that are determined or identified for the trade-in vehicle. The manner in which the quantity of potential trade-in buyers is determined may vary according to the rules and parameters discussed above. In addition, factors other than the quantity of potential buyers may be used to determine the adjusted trade-in amount.

The user interface 900 also may include, in some embodiments, a recondition amount/value block 918, which represents the cost to the vehicle dealer in preparing the trade-in vehicle for resale. In certain embodiments the user may input a value for the recondition amount/value, while in other embodiments the recondition amount/value is determined and displayed in block 918. In those embodiments in which the recondition amount/value is determined the features of the trade-in vehicle, such vehicle type, model, condition or the like may vary the recondition amount/value.

Once the baseline trade-in value and additional trade-in value have been determined and, in some embodiments the recondition amount entered, determined or otherwise considered, the trade-in amount/value is displayed in block 920. The trade-in amount is the amount the dealer should be able to sell the trade-in vehicle for, or stated differently the maximum amount which may be offered to the customer for the trade-in vehicle. In specific embodiments, the trade-in amount is the baseline trade-in amount/value plus (and in some instances minus) the adjusted trade-in amount/value, offset (i.e., subtracted by) the recondition amount/value.

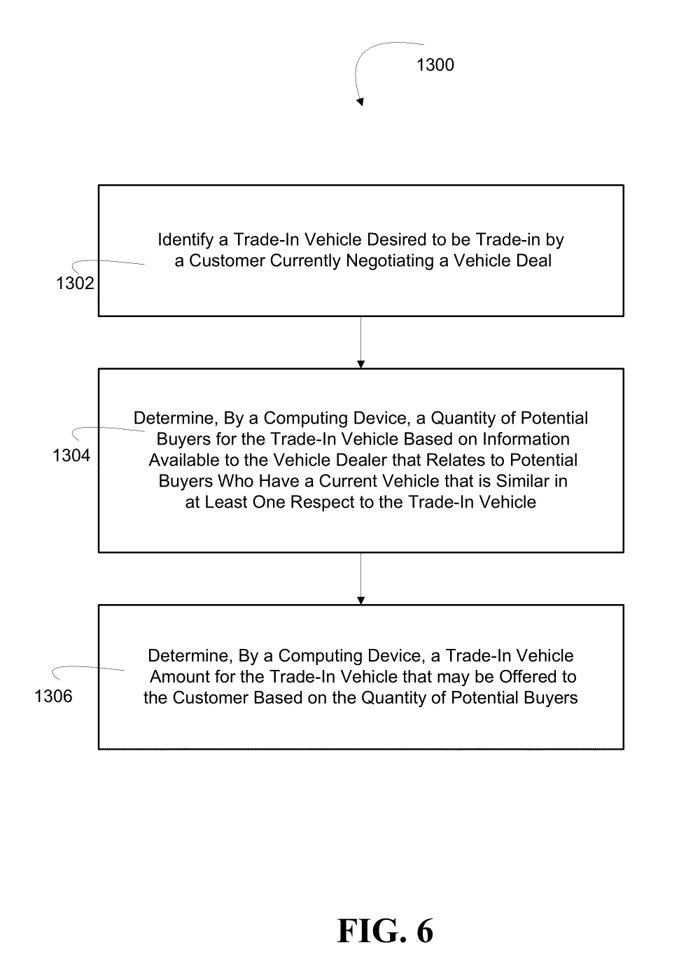

FIG. 6 is a flow diagram of a method 1300 for determining a trade-in amount for a vehicle desired to be traded-in, in accordance with embodiments of the present invention. At Event 1302, a trade-in vehicle is identified that is desired to be trade-in by a customer currently negotiating a vehicle deal, such as currently negotiating a deal at a dealership, online or the like.

At Event 1304, a quantity of potential buyers are determined for the trade-in vehicle based on information available to the dealer that relates to potential buyers who have a current vehicle that is similar in at least one respect to the trade in value. The quantity of potential buyers may be determined while the customer is currently negotiating the vehicle deal. In specific embodiments the quantity of potential customers are determined based at least on having a current vehicle that is a same make and model and a same or earlier model year as the trade-in vehicle. In other embodiments, the quantity of potential buyers are determined based at least on the potential buyers being able to be offered the trade-in vehicle at one of a same monthly payment amount or a lower monthly payment amount than the potential buyer currently pays for his/her current vehicle. In still further embodiments the quantity of potential buyers are determined based at least on current financing status of current vehicle possessed by the one or more potential buyers, such as, but not limited to, a current amount outstanding on a loan or lease of the current vehicle, a number of payments remaining on the loan or lease of the current vehicle, and historical payment data indicating timeliness of making payments for the current vehicle.

In still further embodiments, the quantity of potential buyers are determined based at least on the non-vehicle related financial information associated with the potential buyers, such as, but not limited to, current job status of the potential buyers, current salary/income of the potential buyers, current savings amounts of the potential buyer, and bankruptcy status of the potential buyers.

At Event 1306, a trade-in vehicle amount is determined for the vehicle that may be offered to customer, while the customer is currently negotiating the vehicle deal. The trade-in vehicle amount is based at least on the quantity of potential buyers determined. The trade-in vehicle amount may reflect the baseline trade-in value, the adjusted trade-in amount/value (as determined based at least on the quantity of potential buyers) and the recondition amount/value.

FIG. 7 is a flow diagram of a method 1300 for verifying a trade-in amount for a vehicle desired to be traded-in, in accordance with embodiments of the present invention. At Event 1302, a proposed trade-in amount is identified for a trade-in vehicle that is desired to be trade-in by a customer currently negotiating a vehicle deal, such as currently negotiating a deal at a dealership, online or the like.

At Event 1404, a quantity of potential buyers are determined for the trade-in vehicle based on information available to the dealer that relates to potential buyers who have a current vehicle that is similar in at least one respect to the trade in value. The quantity of potential buyers may be determined while the customer is currently negotiating the vehicle deal. In specific embodiments the quantity of potential customers are determined based at least on having a current vehicle that is a same make and model and a same or earlier model year as the trade-in vehicle. In other embodiments, the quantity of potential buyers are determined based at least on the potential buyers being able to be offered the trade-in vehicle at one of a same monthly payment amount or a lower monthly payment amount than the potential buyer currently pays for his/her current vehicle. In still further embodiments the quantity of potential buyers are determined based at least on current financing status of current vehicle possessed by the one or more potential buyers, such as, but not limited to, a current amount outstanding on a loan or lease of the current vehicle, a number of payments remaining on the loan or lease of the current vehicle, and historical payment data indicating timeliness of making payments for the current vehicle.

In still further embodiments, the quantity of potential buyers are determined based at least on the non-vehicle related financial information associated with the potential buyers, such as, but not limited to, current job status of the potential buyers, current salary/income of the potential buyers, current savings amounts of the potential buyer, and bankruptcy status of the potential buyers.

At Event 1406, a determination is made as to whether the proposed trade-in amount may be offered to the customer based at least on the quantity of potential buyers determined. The proposed trade-in vehicle amount may reflect the baseline trade-in value, the adjusted trade-in amount/value (as determined based at least on the quantity of potential buyers) and the recondition amount/value.

Referring to FIG. 8, an example of a previous vehicle/transaction identifier (i.e., prospective customer identifier) user interface (UI) 100 included in the customer identification module 20, according to a present embodiment of the invention. The prospective customer identifier UI is displayed to the user and is operable to receive user inputs that define parameters for identifying one or more prospective customers. The fields shown in FIG. 5 are by way of example only and, thus other fields may be added to or deleted from the UI 100 without departing from the inventive concepts herein disclosed. UI 100 includes a customer database selection field 106 that is operable to receive inputs that select or choose the database that is to be searched to identify the one or more prospective customers.

The databases that may be chosen from customer database selection field 106 may be an internal or external sales/lease database 30 that includes previous sales/lease customer information and details related to the previous customer transaction including, but not limited to, previous and/or ongoing financial obligation (i.e., loan or lease) associated with the previous vehicle sale/lease. Additionally, the databases may include internal or external service databases 32 that include listings of customer's having previous and/or pending service appointments, the vehicles associated with those scheduled appointments, customers nearing the payoff of their vehicle loan, customers who reside in certain area codes or the like. Also, the databases may be third-party databases 34, such as financial institution databases or the like that include listings of customer's having ongoing vehicle financing/loans established with the financial institution or the like.

In the illustrated embodiment of FIG. 8, the customer database selection field 106 provides for a drop-down window that may display a plurality of database choices. For example, the database choices may include different dealerships or business units within a company. Thus, the customer database selection field 106 may be configured in those instances in which the user has access to multiple different customer databases. This is especially relevant to a vehicle manufacturer who often has access to a number of databases relating to customers for the manufacturer's vehicles, different regions of a state or country, etc.

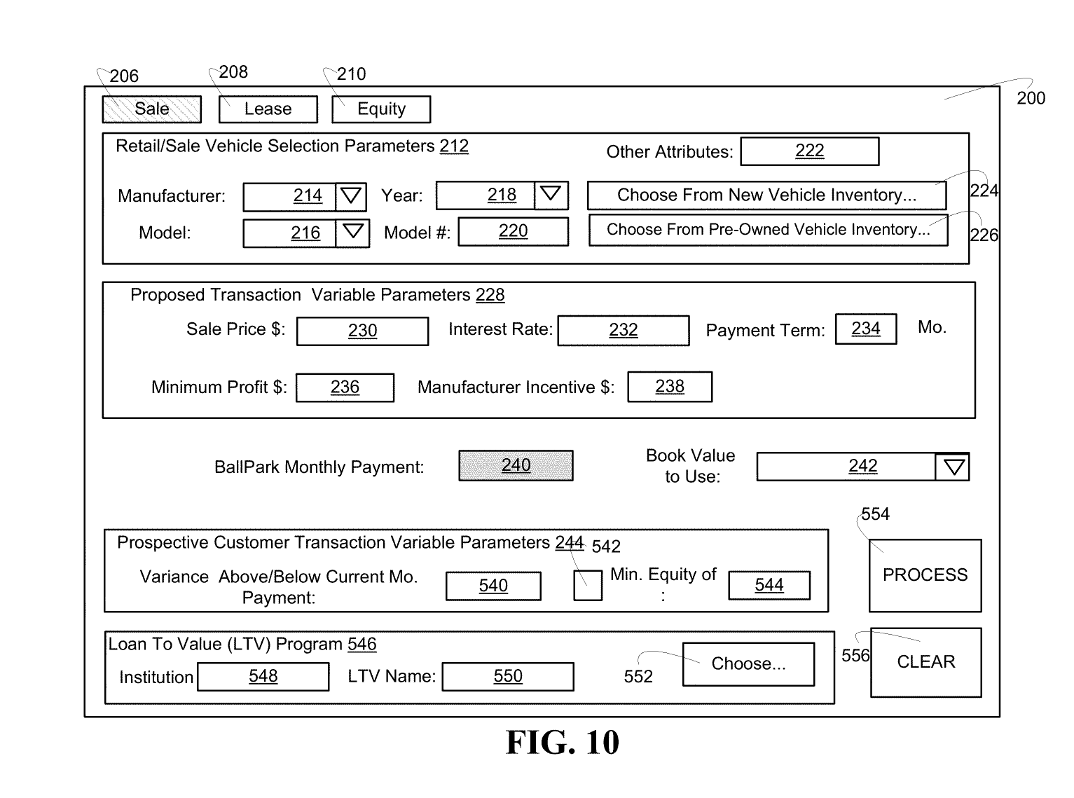

It should be noted that, in other instances in which the customer identification module 20 does not rely on a dealer database to identify a group of prospective customers, UI 20 may be used to define the previous transaction financial terms for a prospective customer. In this instance, the prospective customer may not be a previous sales or service customer, but instead, may be any potential customer. For example, if a customer that has had no prior relationship with a dealership contacts the dealership and makes it aware of the financial terms of the customer's previous transactions, a sales associate or the like may enter that information into UI 100 and proceed to UI 200 (FIG. 10) for identification of a vehicle best suited for offering to the prospective customer and the determination of the proposed financial terms of a proposal associated with the identified vehicle. In turn, the customer identification module 20 may determine a proposal that will be extended to that particular customer and that particular customer only.

The UI 100 includes previous vehicle and vehicle financial transaction parameters 108 that are selected by the user and serve as the match or search criteria for determining the group of prospective customers. Parameters 108 may include, but are not limited to, vehicle product sale/lease status field 110 which provides for the user to select between previous sale/lease transactions for new vehicles 112, pre-owned vehicles 114, other designated vehicles 116 or all of the vehicles 118. Additionally, parameters 108 include a vehicle transaction type field 120 which provides for the user to select between previous contract types, such as retail/sales contracts 122, lease contracts 124 and all contracts 126.

Parameters 108 also include current vehicle type parameters 128 that include, but are not limited to, manufacturer field 130, model field 132, year field 134, model number field 136 and other attribute field 138 such as body style or the like. Similar to the customer database selection field 106, the vehicle parameter fields may provide for a drop-down window for selecting a parameter from a drop-down list or the field may require data entry, such as the model number field 136. The drop-down lists may be presented based on a subsequent selection, for example, selection of a vehicle manufacturer may dictate which model drop-down list appears and the selection of the model may dictate which year drop-down lists appears.

Additionally, parameters 108 may include an email address field 140 which provides for the user to select whether the group of prospective customers includes an email address in the database. As discussed in detail infra., an email address is beneficial for those embodiments of the invention in which the customer identification module 20 includes a routine for generating and initiating the communication of emails that include the information about the identified vehicle, including a potential vehicle proposal. The email address field 140 may include a drop-down window that allows the user to choose between those customers having an email address, those customers not having an email address and all customers.

Previous vehicle and vehicle transaction parameters 108 also include current vehicle transaction parameters 142. The previous transaction parameters include a salesperson field 144 for identifying the salesperson associated with the previous sales/lease transaction, a finance manager field 146 for identifying the finance manager associated with the previous sales/lease transaction, a customer name field 148 for limiting the prospective customers to one specific previous customer, a zip code field 150 for identifying a specific zip code for previous sales/leases and a transaction year field 152 for identifying the year in which the previous transaction transpired.

Additionally, previous vehicle and vehicle financial transaction parameters 108 include current vehicle financial obligation parameters 154. The financial obligation parameters 154 include the minimum and maximum finance/interest rate fields 156 and 158 that allow the user to identify a maximum and/or minimum finance/interest rate for the previous vehicle transactions; the minimum and maximum monthly payment fields 160 and 162 that allow the user to identify maximum, minimum and/or range of monthly payment amounts for previously financed transactions; the minimum and maximum finance term fields 164 and 166 that allow the user to identify the minimum and/or maximum range of finance terms; and the minimum and maximum money factor fields 168 and 170 that allow the user to identify the minimum and/or maximum lease contract money factor. Financial obligation parameters 154 may also include a last payment year field 172 that allows the user to identify a year for which the last payment is due in outstanding finance obligations.

The previous vehicle/transaction identifier/prospective customer identifier UI 100 also includes a search key 176 operable to be engaged by the user to initiate the search from the selected customer database for the one or more prospective customers that meet the criteria as defined by the previous vehicle and vehicle financial transaction parameters 108 which the user has selected to input. As noted, only one or more parameters need to be inputted in order for the search process to identify a group of prospective customers. Additionally, the previous vehicle/transaction identifier/prospective customer identifier UI 100 also includes a clear key 178 operable to be engaged to clear all of the fields on the UI 100 in order to conduct a further search of prospective customers.

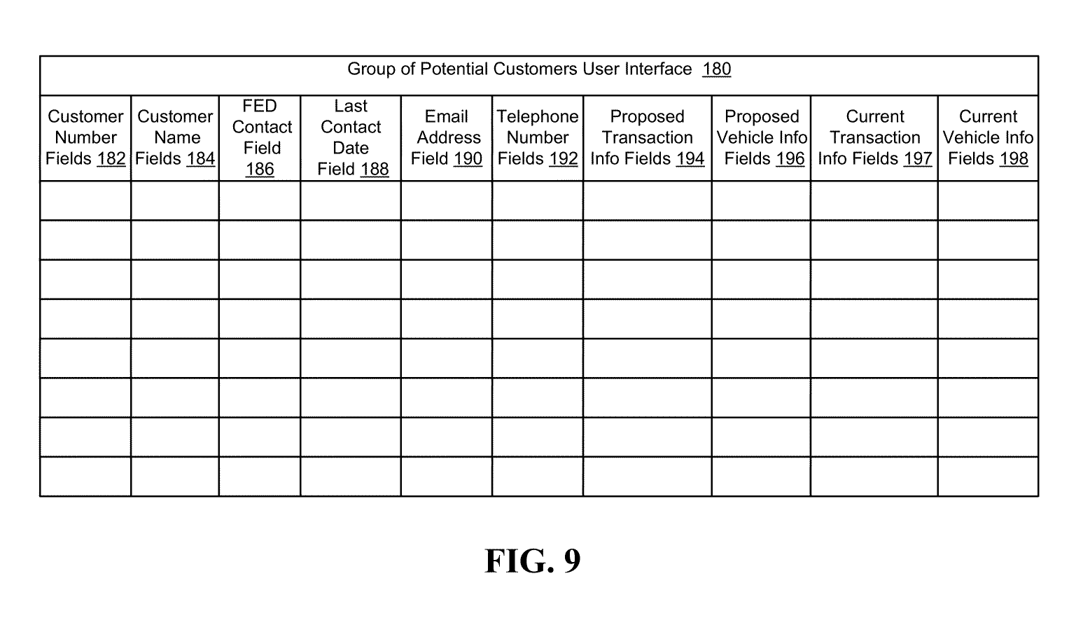

Referring to FIG. 9, a schematic example of a group of prospective customers User Interface (UI) 180 is shown, in accordance with another present embodiment of the invention. The display panel 180 may be displayed upon engaging the search key 176 in the previous vehicle/transaction identifier/prospective customer identifier UI 100 (shown in FIG. 8). The UI 180 includes a listing of prospective customers based on the customers meeting the criteria defined in the previous vehicle/transaction identifier/prospective customer identifier UI 100. The display panel 180 may include customer number field(s) 182 for displaying one or more assigned customer numbers; customer name fields 184 for displaying a first, last and other name associated with the customer; a FED contact field 186 for identifying the customer as being contactable under the federal telemarketing harassment laws; a last contact date field 188 for indicating the last date that the prospective customer was contacted/solicited; an email address filed 190 for identifying the customer's known email address; and telephone number fields 192 for identifying one or more telephone numbers associated with the customer.

The display panel 180 may also include proposal information fields 194 for identifying terms related to the potential vehicle proposal, proposed vehicle information fields 196 for identifying the make, model, year, trim line, options, etc. of the proposed vehicle being offered; current financial transaction fields 197 for indicating the terms related to the current ongoing financial transaction obligations and current vehicle information fields 198 for indicating the make, model, year, trim line, options, etc. of the current customer vehicle. In accordance with certain embodiments, the fields depicted in UI 180 may be sortable fields such that clicking-on or otherwise activating the field title provides for a sort listed within that particular field.

Referring to FIG. 10, a block diagram is depicted of an example of a retail/sales vehicle selection and sales parameter identifier User Interface (UI) 200 included in the customer identification module 20, according to a present embodiment of the invention. The UI 200 includes a sales key 206, a lease key 208 and an equity key 210 for the user to select between sales vehicle selection, lease vehicle selection and equity UIs. In the illustrated embodiment of FIG. 10, the user has engaged the sales key 206 to display the associated retail/sales vehicle selection and sales transaction parameter identifier UI 200. The fields shown in FIG. 10 are by way of example only and, thus other fields may be added to or deleted from the UI 200 without departing from the inventive concepts herein disclosed.

The UI 200 includes vehicle parameters 212 that provide entry fields for identifying the vehicle for which the user desires to sell. The vehicle parameters may include, but are not limited to, a manufacturer field 214, a model field 216, a year field 218, a model number field 220 and other attribute field 222, such as a body type field or the like. The vehicle parameter fields may provide for a drop-down window for selecting a parameter for drop-down list or the field may require data entry, such as the model number field 220. The drop-down lists may be presented based on a subsequent selection, for example, selection of a vehicle manufacturer may dictate which model drop-down list appears and the selection of the model may dictate which year drop-down lists appears. In addition, vehicle parameters 212 may include a choose new vehicle key 224 that is operable to be engaged to display a listing of new vehicles currently available from the dealership, from the dealership network and/or from the manufacturer and a pre-owned vehicle key 226 that is operable to be engaged to display a listing of pre-owned vehicles currently available from the dealership, or from the dealership network. It will be understood that when embodiments of the present invention are implemented by a vehicle manufacturer, the vehicle parameters will be specific to vehicles manufactured or considered to be manufactured by that particular manufacturer.

The UI 200 also includes proposed retail/sales transaction variable parameters 228. The proposed transaction terms 228 include sales price field 230 to provide for the user to input a desired sale price, finance/interest rate field 232 to provide for the user to input a current vehicle program interest rate, term field 234 to provide for the user to input a current vehicle program term, a minimum profit field 236 that allows for the user to input a desired profit amount on the sale of the proposed vehicle and a manufacturer incentive field 238 that allows the user to input the vehicle incentive program currently being offered. It will be understood that when embodiments of the present invention are implemented by a vehicle manufacturer, the terms are terms that the manufacturer can apply to its vehicles consistent with the manufacturer's costs, etc.

The UI 200 may also include a “ballpark”/estimated monthly payment indicator 240 that displays a calculated monthly payment estimate based on inputted data, such as sales price, finance rate, and term data entered in the proposed transaction parameter fields. Additionally, UI 200 may include a book-value selector 242 that allows the user to select the book value type to use in determining the market value of the prospective customers current vehicle. The book-value selector may be in the form of a drop-down window that displays all available book-value options and allows the user to select from the displayed options.

UI 200 may also include prospective customer transaction variable parameters 244. The prospective customer transaction variable parameters 244 may include, but are not limited to, a variance amount above/below the current monthly payment amount field 246 that allows for the user to define an amount below/above the current monthly amount that the identified prospective customers may find acceptable. Additionally, parameters 244 may include a check box 248 for indicating whether a prospective customer requires positive equity (i.e., sales/trade-in value exceeds the amount owed) to be further considered as prospective customer to which the proposal will be offered. If check box 248 is engaged, minimum equity field 250 allows for the user to define the minimum equity that the prospective customer must have in the current vehicle. It should be noted that the prospective customer transaction variable parameters 244 define further criteria for prospective customer inclusion in the group of prospective customers to which the proposal will be offered to. Thus, the search of prospective customers that results from the prospective customer identifier UI (FIG. 8) may be further limited based on the user defined prospective customer variable parameters 244.

Additionally, UI 200 may optionally include a Loan-To-Value (LTV) program parameters 252. The LTV program parameters 252 may include, but are not limited to the financial institution field 254 that allows for the user to input a financial institution name and a LTV program name field 256 that allow for the user to input a LTV program name. Alternatively, the LTV program parameters 252 may include an LTV program choose key 258 operable to be engaged by the user to provide for a listing of LTV programs to choose from.

UI 200 also includes a process key 260 that may be engaged by the user after all of the desired fields in UI 200 have inputs. The process key 260 will initiate the determination of the sales proposal for each of the prospective customers in the identified group. The determination process may include determining the book value of the current vehicle of the prospective customer, determining an estimated payoff amount for the current prospective customer's vehicle, determining estimated sales taxes, determining an estimated financed amount and determining an estimated monthly payment. Once the determinations have been completed and a proposal determined for each of the prospective customers, a report is generated for each of the prospective customers that includes the sales proposal. The clear key 262 allows the user to clear all of the fields in UI 200 to initiate new search criteria for a proposed vehicle sale.

Those of skill in the art will understand some or all of the described and illustrated fields may be filled in electronically by optionally coupling the described modules with other systems at the dealership or manufacturer. In addition, the reports and information provided by the reports can likewise be made available electronically to other systems. In this way the reports can be used to assist in the overall management and administration of the user, particularly as it relates to existing or anticipated inventory of vehicles of the user, and the manufacturer of vehicles.

It should be noted that while the customer identification module 20 generally implements UI 200 in conjunction with UI 100 to identify prospective customers to target for communication s, identify the vehicle to offer those prospective customers and the terms of the new proposal, it is possible, and within the inventive concepts herein disclosed, to implement UI 200 for the sole purpose of identifying or locating a specific vehicle and the terms associated with a proposal for the vehicle. For example, if the customer has no prior relationship with the user or the customer has no outstanding financial obligation on his/her current vehicle, the user may desire to use the vehicle identification aspect of the customer identification module 20 to locate a vehicle desired by the customer and to identify the terms of a financial proposal associated with the located vehicle. Such implementation of UI 200 and the concept of vehicle identification are especially suited in instances in which the customer identification module 20 is used across multiple dealerships or an entire manufacturer, such that the vehicles in the database extend beyond just one dealership.

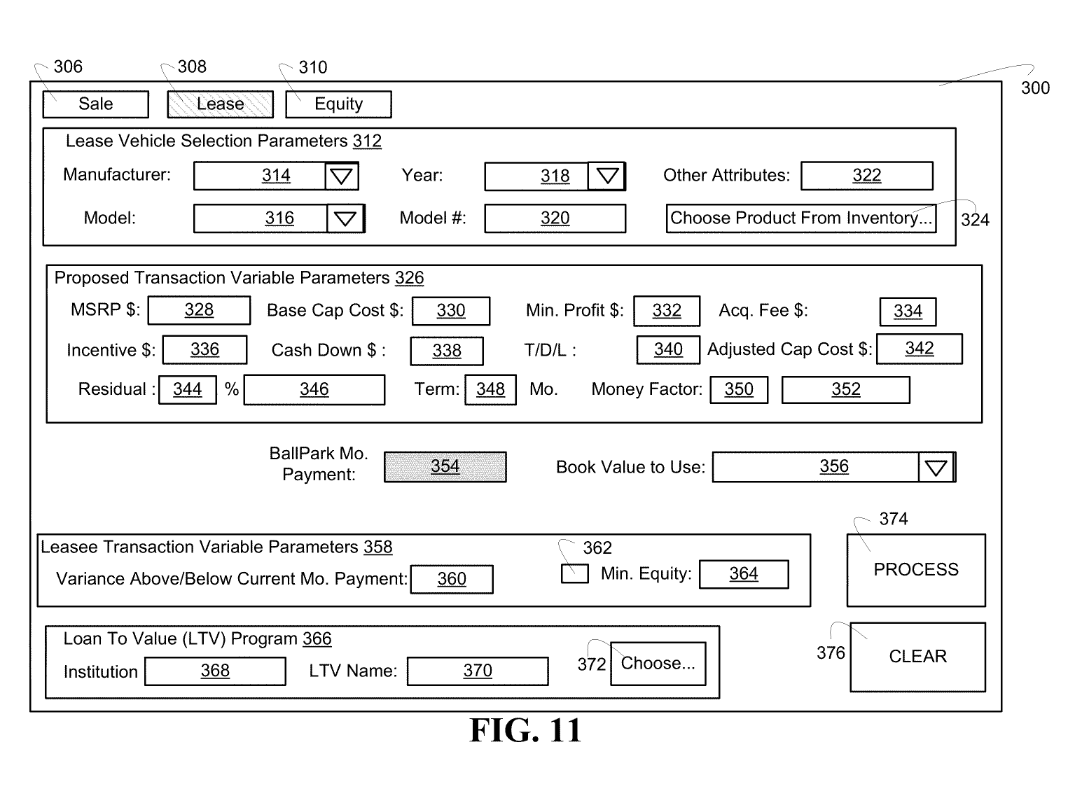

Referring to FIG. 11, a block diagram is depicted of an example of a lease vehicle selection and lease transaction parameter identifier User Interface (UI) 300 included in the customer identification module 20, according to a present embodiment of the invention. The UI 300 includes a sale key 306, a lease key 308 and an equity key 310 for the user to select between sale vehicle selection, lease vehicle selection and equity. In the illustrated embodiment of FIG. 11, the user has engaged the lease key 308 to display the associated lease vehicle selection and lease transaction parameter identifier UI 300. The fields shown in FIG. 11 are by way of example only and, thus other fields may be added to or deleted from the UI 300 without departing from the inventive concepts herein disclosed.

The UI 300 includes vehicle parameters 312 that provide entry fields for identifying the vehicle in actual or prospective inventory for which the user desires to identify a group of prospective customers. The vehicle parameters may include, but are not limited to, a manufacturer field 314, a model field 316, a year field 318, a model number field 320 and other attribute field 322, such as a body type field or the like. The vehicle parameter fields may provide for a drop-down window for selecting a parameter for drop-down list or the field may require data entry, such as the model number field 320. The drop-down lists may be presented based on a subsequent selection, for example, selection of a vehicle manufacturer may dictate which model drop-down list appears and the selection of the model may dictate which year drop-down lists appears. In addition, vehicle parameters 312 may include a “choose vehicle” key 324 that is operable to be engaged to display a listing of vehicles currently available from the dealership, from the dealership network or from the manufacturer.

The UI 300 also includes proposed lease transaction variable parameters 326. The proposed lease transaction parameters 326 include a manufacturer's suggested retail price (MSRP) field 328 to provide for the user to input the MSRP, a base cap cost field 330 to provide for the user to input the actual sale price proposed to retail customers, a minimum profit field 332 to provide for the user to input desired minimum profit for the dealership for the lease period, an acquisition fee field 334 that allows for the user to input the acquisition cost associated with the proposed lease vehicle, and a manufacturer incentive field 336 that allows the user to input the vehicle incentive program currently being proposed. The proposed lease transaction variable parameters 326 also include a cash down field 338 that allows the user any customer cash needed for the lease, a tax, title and documentation field 340 that allows the user to input, or alternatively display, the tax, title and documentation fees associated with the proposed lease vehicle, and the adjusted cap cost field 342 that displays a calculated cap cost based on other inputted proposed lease transaction parameters. In alternative embodiments, the title, documentation and/or tax may be listed in individual fields.

The proposed lease transaction variable parameters 326 may also include residual percentage field 344 that allows the user to input a residual percentage that represents the residual value of the proposed vehicle after the completion of the lease term. The residual field 346 displays the residual value of the proposed lease vehicle. Parameters 326 also include term field 348 that allows the user to input a lease contract term and money factor percentage field 350 that allows the user to input the money factor percentage associated with the lease contract. The money factor field 352 displays the actual money factor used in the lease contract. Money factor is the alternative means of presenting the amount of interest charged on a lease with monthly payments.

The UI 300 may also include a “ballpark”/estimated monthly payment indicator 354 that displays a calculated monthly payment estimate based on inputted data, such as Manufacturer's Suggested Retail Price (MSRP), residual rate, payment term, money factor and the like the proposed lease transaction parameter fields. Additionally, UI 300 may include a book-value selector 356 that allows the user to select the book value type to use in determining the market value of the prospective customers current vehicle. The book-value selector may be in the form of a drop-down window that displays all available book-value options and allows the user to select from the displayed options.

UI 300 may also include prospective leasee/customer transaction variable parameters 358. The lessee variable transaction parameters 358 may include, but are not limited to, a variance amount above/below the current monthly payment amount field 360 that allows for the user to define an amount/below above the current monthly amount that the group of prospective customers may find acceptable. Additionally, parameters 358 may include a check box 362 for indicating whether a prospective customer requires positive equity to be further considered as prospective customer to which the proposal will be offered. If check box 362 is engaged, minimum equity field 364 allows for the user to define the minimum equity that the prospective customer must have in the current vehicle. It should be noted that the prospective customer transaction variable parameters 358 define further criteria for prospective customer inclusion in the group of prospective customers to which the proposal will be made. Thus, the search of prospective customers that results from the prospective customer identifier UI (FIG. 8) may be further limited based on the user defined prospective customer variable parameters 358.

Additionally, UI 300 may optionally include a Loan-To-Value (LTV) program parameters 366. The LTV program parameters 366 may include, but are not limited to, the financial institution field 368 that allows for the user to input a financial institution name and a LTV program name field 370 that allow for the user to input a LTV program name. Alternatively, the LTV program parameters 366 may include an LTV program choose key 372 operable to be engaged by the user to provide for a listing of LTV programs to choose from.

UI 300 also includes a process key 374 that may be engaged by the user after all of the desired fields in UI 300 have inputs. The process key 374 will initiate the determination of the sales proposal for each of the prospective customers in the identified group. The determination process may include determining the book value of the current vehicle of the prospective customer, determining an estimated monthly finance charge, determine a proposed finance charge, determine total sales tax, determine an estimated monthly depreciation charge and determine and set the lease turn-in alert. Once the determinations have been completed and a proposal determined for each of the prospective customers, a report is generated for each of the prospective customers that includes the potential lease terms. The clear key 376 allows the user to clear all of the fields in UI 300 for the purpose of inputting new search criteria into fields shown in UI 300.

Those of skill in the art will understand some or all of the described and illustrated fields may be filled in electronically by optionally coupling the described modules with other systems at the dealership or manufacturer. In addition, the reports and information provided by the reports can likewise be made available electronically to other systems. In this way the reports can be used to assist in the overall management and administration of the user, particularly as it relates to existing or anticipated inventory of vehicles of the user, and the manufacturer of vehicles.

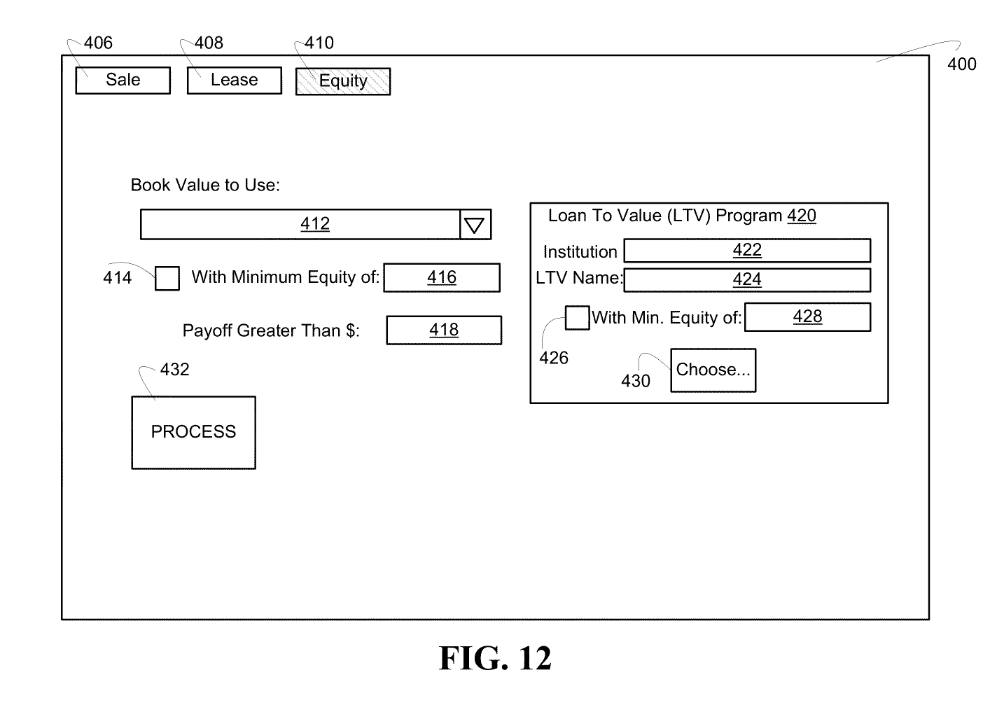

Referring to FIG. 12 a block diagram is depicted of an example of an equity vehicle selection User Interface (UI) 400 included in the customer identification module 20, according to a present embodiment of the invention. The UI 400 includes a sale key 406, a lease key 408 and an equity key 410 for the user to select between sale vehicle selection, lease vehicle selection and equity. In the illustrated embodiment of FIG. 12, the user has engaged the equity key 410 to display the associated equity vehicle selection UI 400. The equity vehicle selection UI 400 provides for potential vehicle proposals absent a previous sale/lease and/or ongoing financial obligation with the dealership. The fields shown in FIG. 12 are by way of example only and, thus other fields may be added to or deleted from the UI 400 without departing from the inventive concepts herein disclosed.

UI 400 includes a book-value selector 412 that allows the user to select the book value type to use in determining the market value of the prospective customers current vehicle. The book-value selector may be in the form of a drop-down window that displays all available book-value options and allows the user to select from the displayed options.

UI 400 may include a check box 414 for indicating whether a prospective customer requires positive equity to be further considered as prospective customer to which the proposal will be offered. If check box 414 is engaged, minimum equity field 416 allows for the user to define the minimum equity that the prospective customer must have in the current vehicle. Payoff-greater-than field 416 allows for the user to input an amount for which the payoff must be greater than.

UI 400 may optionally include a Loan-To-Value (LTV) program parameters 420. The LTV program parameters 420 may include, but are not limited to, the financial institution field 422 that allows for the user to input a financial institution name and a LTV program name field 424 that allow for the user to input a LTV program name. Parameters 420 may also include a check box 426 for indicating whether a prospective customer requires positive equity to be further considered for a LTV program. If check box 426 is engaged, minimum equity field 428 allows for the user to define the minimum equity that the prospective customer must have in the current vehicle. Alternatively, the LTV program parameters 420 may include an LTV program choose key 430 operable to be engaged by the user to provide for a listing of LTV programs to choose from.

Additionally, UI 400 includes a process key 432 that may be engaged by the user after all of the desired fields in UI 400 have inputs. The process key 432 will initiate the determination of the sales proposal for the prospective customer.

Those of skill in the art will understand some or all of the described and illustrated fields may be filled in electronically by optionally coupling the described modules with other systems at the dealership or manufacturer. In addition, the reports and information provided by the reports can likewise be made available electronically to other systems. In this way the reports can be used to assist in the overall management and administration of the user, particularly as it relates to existing or anticipated inventory of vehicles of the user, and the manufacturer of vehicles.

Further other types of user interfaces may be implemented in accordance with the invention that allow a user to input other information, such as, but not limited to, actual or prospective inventory of specific vehicles and the like.

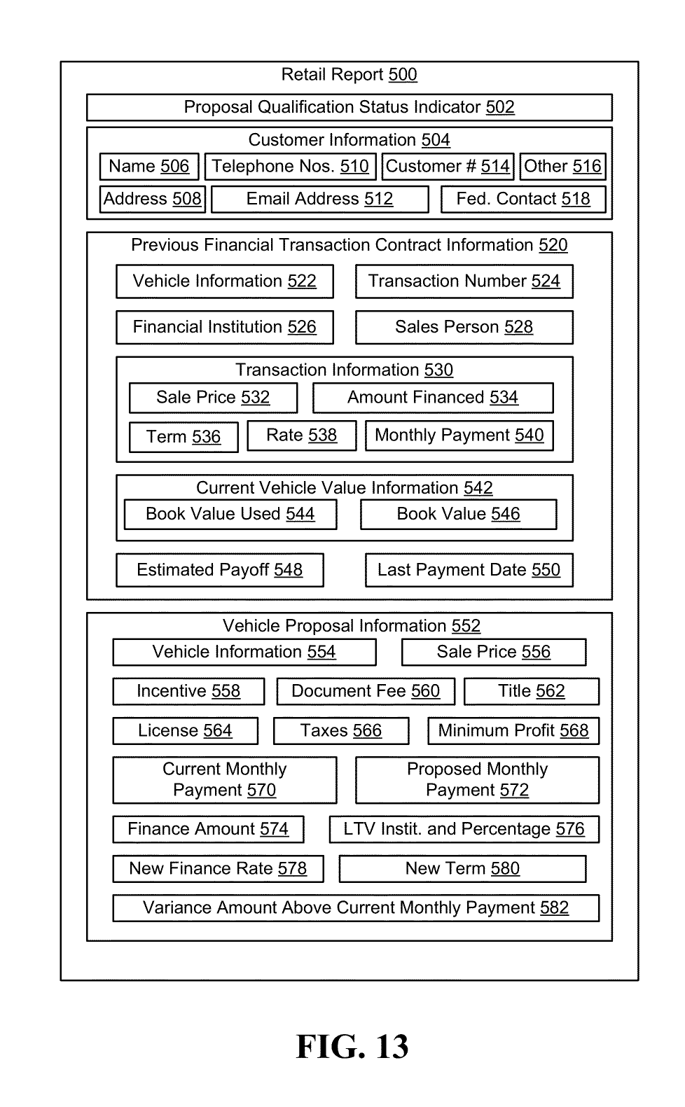

Referring to FIG. 13, a block diagram is depicted of a retail/sales report 500 generated as a result of determining a targeted and customized sales proposal for a prospective customer, in accordance with an embodiment of the present invention. The retail/sales report 500 is generally used for internal purposes and therefore may be limited in distribution to sales personnel and other employees of the dealership. Information found in the retail report 500 may form the basis for the information presented in the communication to the prospective customer. As previously noted, the communication to the prospective customer, which may include a proposal may take the form of an electronic communication, such as an email, a text or the like, a mailing, a telephone call and/or an in-person encounter.

The retail report 500 may include a qualification status indicator 502 that indicates the qualification status of the customer based on predetermined qualification criteria. For example, in one embodiment the qualification status indicator may indicator that a customer is a “hot” qualifier, “medium” qualifier or “cold” qualifier based on the predetermined qualification criteria.

The report 500 also includes customer information 504 that identifies the customer and contact information associated with the customer. For example, the customer information 504 may include, but is not limited to, a name 506, an address 508 telephone numbers 510, an email address 512, a customer number 514 associated with a previous vehicle transaction and any other information 516, such other electronic communication addresses, number of previous new and/or pre-owned purchases/leases with the dealership, amount of previous purchases/leases, previous vehicle services at the dealership, amount paid for the services or the like. The customer information 504 may also include the federal contact status 518, which indicates if the customer currently has do-not-call status. The available contact information for any one prospective customer may form the basis for determining which means is used to communicate the potential vehicle proposal to the prospective customer.

In the instance in which the sales report 500 is generated for a service customer, the other information 516 may include, but is not limited to, the pending service appointment number, the service appointment date, the service appointment time, the name of the service appointment advisor or the like

The retail report 500 may also include information 520 related to the previous/ongoing financial transaction associated with the prospective customers current vehicle. This information may include current vehicle information 522, such as the new/pre-owned status, make, model, year, model number, body type, Vehicle Identification Number (VIN), and the estimated miles on the vehicle or the like, a transaction number 524 associated with the previous vehicle transaction, a financial institution 526 that is carrying the current financial obligation and a salesperson and/or financing manager 528 involved in the previous vehicle transaction. The information 520 may also include transaction information 530, such as, but not limited to, the sale price 532, the amount of the sale price financed 534, the term of the loan 536, the finance rate of the loan 538 and the monthly payment 540 for the loan. Additionally, information 520 may also include current vehicle value information 542, such as the book value used 544 and the determined book value amount 546. The previous/ongoing financial transaction contract information 520 may also include an estimated payoff 548 and a last payment due date 550. The estimated payoff amount 548 is determined as part of the potential vehicle proposal determination and is based on the current term, the finance rate, the amount financed and the number of estimated payments made since the inception of the sales contract.

The retail report 500 also includes information 552 related to potential terms under which a vehicle is offered. The potential vehicle proposal information 552 may include vehicle information 554, such as the make, model, year, model number, body style or the like, the proposed sale price 556, dealer incentive 558, the document fees 560, the title fee 562, the license fee 564 and the taxes 566. The potential vehicle proposal information 552 may also include the minimum profit desired by the dealer 568, the current monthly payment 570 and the proposed monthly payment amount 572 that is calculated as part of the determination of the potential vehicle proposal and is based on the proposed finance amount, the term of the loan and the finance rate. Additionally, information 552 may include finance amount 574, which may also be determined as part of the determination of the potential vehicle proposal and is based on sale price, minimum desired profit, estimated payoff amount, dealer incentives, book value of the current vehicle and tax, title license and documentation fees. Thus, the potential vehicle proposal information 552 may also include the LTV institution and percentage 576, the finance rate 578, the proposed term 580, and the variance amount above the current monthly payment 582.

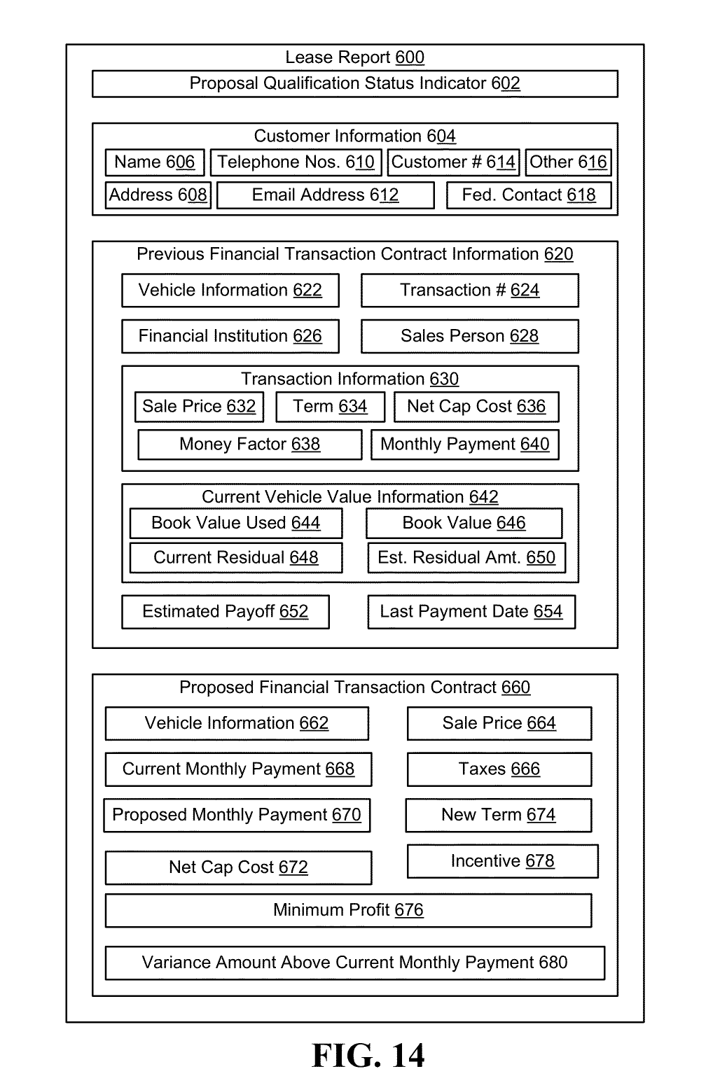

Referring to FIG. 14, a block diagram is depicted of a lease report 600 generated as a result of determining a targeted and customized potential lease terms for a prospective customer, in accordance with an embodiment of the present invention. The lease report 600 is generally used for internal purposes and therefore may be limited in distribution to sales personnel and other employees of the dealership. Information found in the lease report 600 will form the basis for the information presented in the potential vehicle proposal to the prospective customer. As previously noted, the proposal to the prospective customer may take the form of an electronic proposal, such as an email proposal, a text proposal or the like, a mail proposal, a telephone proposal and/or an in-person proposal.

The lease report 600 may include a proposal qualification status indicator 602 that indicates the qualification status of the customer based on predetermined qualification criteria. For example, in one embodiment the qualification status indicator may indicate that a customer is a “hot” qualifier, “medium” qualifier or “cold” qualifier based on the predetermined qualification criteria.

The lease report additionally includes customer information 604 that identifies the customer and contact information associated with the customer. For example, the customer information 604 may include, but is not limited to, a name 606, an address 608, telephone numbers 610, an email address 612, a customer number 614 associated with a previous vehicle transaction and any other information 616, such other electronic communication addresses, number of previous new and/or pre-owned purchases/leases with the dealership, number of previous purchases/leases, previous vehicle services at the dealership, amount of the services or the like. The customer information 604 may also include the federal contact status 618, which indicates if the customer currently has do-not-call status. The available contact information for any one prospective customer may form the basis for determining which means is used to communicate the potential vehicle proposal to the prospective customer.

The lease report 600 may also include information 620 related to the previous/ongoing financial transaction associated with the prospective customers current vehicle. This information may include current vehicle information 622, such as the make, model, year model number, body type or the like, a transaction number 624 associated with the previous vehicle transaction, a financial institution 626 that is carrying the current financial obligation and a salesperson 628 involved in the previous vehicle transaction. The information 620 may also include transaction information 630, such as, but not limited to, the lease price 632, the term of the lease 634, the net cap cost 636, the money factor 638 of the current lease and the monthly payment 640 for the current lease. Additionally, information 620 may also include current vehicle value information 642, such as the book value used 644, the determined book value amount 646, the current residual 648 and the estimated residual amount 650. The previous/ongoing financial transaction contract information 620 may also include an estimated payoff 652 and a last payment due date 654.

The lease report 600 also includes information 660 related to the vehicle associated with the lease. The vehicle information 660 may include vehicle information 662, such as the make, model, year, model number, body style or the like, the proposed sale price 664, and the taxes 666. The vehicle information 660 may also include the current monthly finance amount 668 and proposed monthly finance amount 670 that is calculated as part of the determination of the vehicle proposal and is based on the sum of the proposed vehicle monthly depreciation fee, plus the monthly finance fee. Additionally, information 660 may include, the net cap cost 672, the proposed term 674, the minimum profit desired by the dealer 676 and the incentive 678 associated with this lease. In addition, the proposed potential vehicle proposal information 660 may include variance amount above the current monthly payment 680

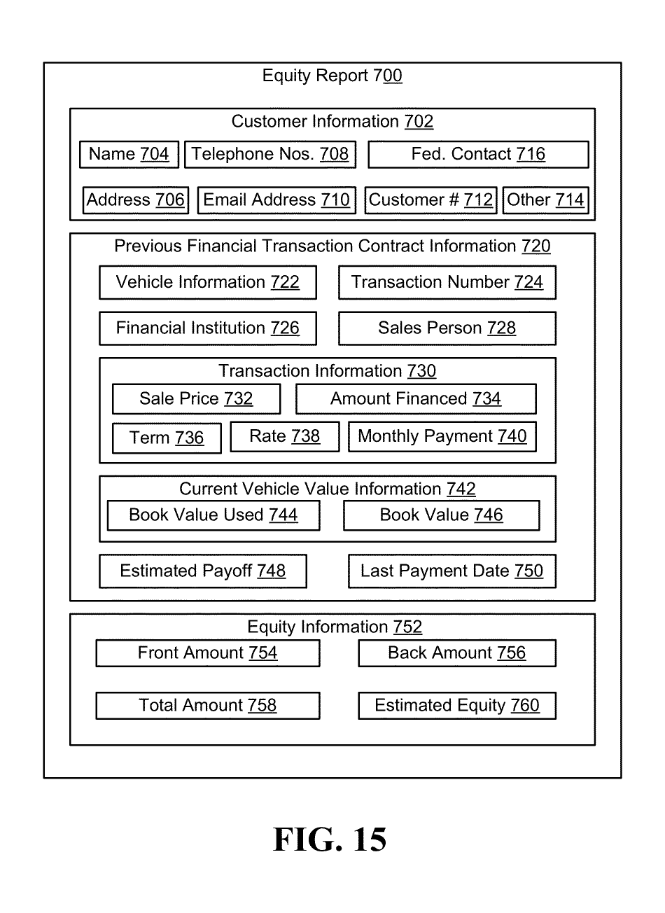

Referring to FIG. 15, a block diagram is depicted of an equity report 700 generated as a result of determining equity for a prospective customer, in accordance with an embodiment of the present invention. The equity report 700 is generally used for internal purposes and therefore may be limited in distribution to sales personnel and other employees of the dealership. Information found in the equity report 700 can form the basis for at least some of the information presented in communicating with a prospective customer. As previously noted, the communication to the prospective customer, which may include a potential proposal may take the form of an electronic communication, such as an email, a text or the like, a mailing, a telephone call and/or an in-person encounter, any one of which may include as well, other information that may be of interest to the prospective customer to assist the user in marketing the vehicle identified from its inventory.

The equity report 700 includes customer information 702 that identifies the customer and contact information associated with the customer. For example, the customer information 702 may include, but is not limited to, a name 704, an address 706 telephone numbers 708, an email address 710, a customer number 712 associated with a previous vehicle transaction and any other information 714, such other electronic communication addresses, number of previous new and/or pre-owned purchases/leases with the dealership, amount of previous purchases/leases, previous vehicle services at the dealership, amount of the services, last payment date or the like. The customer information 702 may also include the federal contact status 716, which indicates if the customer currently has do-not-call status. The available contact information for any one prospective customer may form the basis for determining which means is used to communicate the potential vehicle proposal to the prospective customer.

The equity report 700 may also include information 720 related to the previous financial transaction contract associated with the prospective customer's current vehicle. This information may include current vehicle information 722, such as the new/pre-owned status, make, model, year, model number, body type, Vehicle Identification Number (VIN), and the estimated miles on the vehicle or the like, a transaction number 724 associated with the previous vehicle transaction, a financial institution 726 that is carrying the current financial obligation and a salesperson and/or financing manager 728 involved in the previous vehicle transaction. The information 720 may also include transaction information 730, such as, but not limited to, the sale price 732, the amount of the sale price financed 734, the term of the loan 736, the finance rate of the loan 738 and the monthly payment 740 for the loan. Additionally, information 720 may also include current vehicle value information 742, such as the book value used 744 and the determined book value amount 746. The previous/ongoing financial transaction contract information 520 may also include an estimated payoff 748 and a last payment due date 750. The estimated payoff amount 748 is determined as part of the potential vehicle proposal determination and is based on the current term, the finance rate, the amount financed and the number of estimated payments made since the inception of the sales contract.

The equity report 700 additionally includes equity information 752 which includes a front amount 754, a back amount 756, a total amount 758 and an estimated equity amount 760.

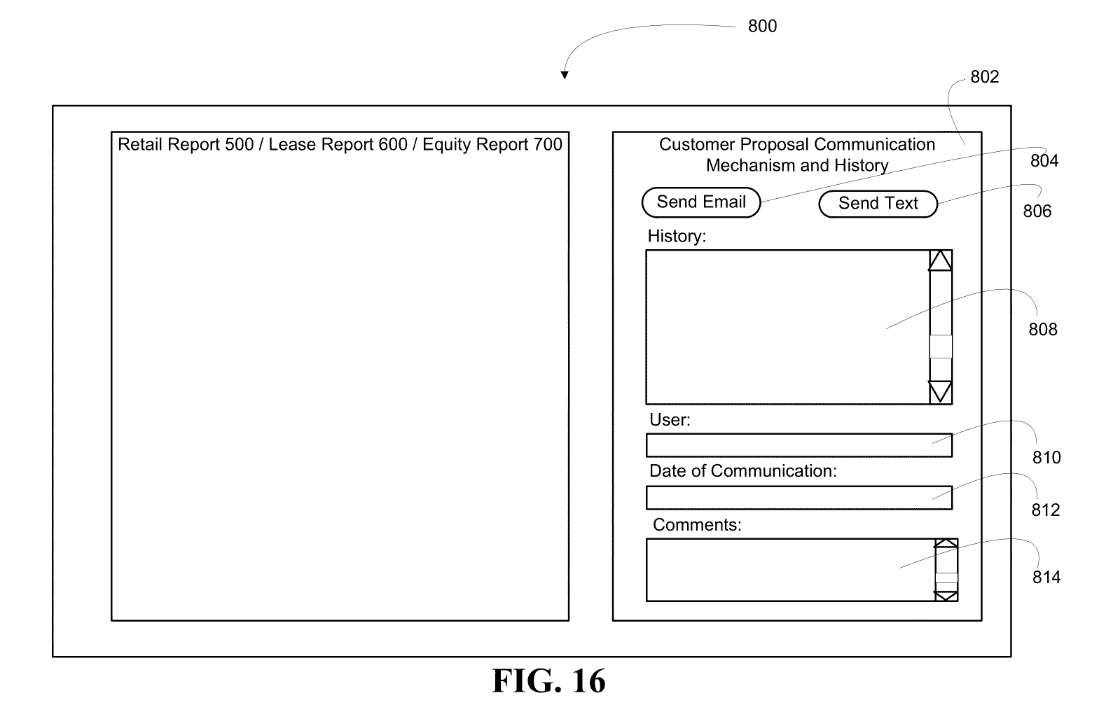

Referring to FIG. 16 a block diagram is illustrated that depicts an example of a joint proposal report and prospective customer communication history User Interface (UI) 800, in accordance with an embodiment of the present invention. One portion of the UI 800 may include a depiction of the retail report 500, lease report 600 or equity report 700 shown in FIGS. 13, 14 and 15, respectively.

Another portion of UI 800 includes the prospective customer proposal communication mechanism and history 802. Input key 804 provides for generating and communicating an email message to the prospective customer that includes an appropriate communication including portions of the potential proposal detailed in the report 500, 600 or 700 shown in UI 800. Likewise, input key 806 provides for generating and communicating a text/Short Message Service (SMS) to the prospective customer that includes the appropriate communication, including some or all or the potential transaction terms in the report 500, 600 or 700 shown in UI 800. It should be noted that UI 800 may include other input keys for generating and communicating other forms of known or future known electronic communication, including all types of social media and the like. Additionally, in specific embodiments the input keys 804 or 806 may only be displayed or configured to be activated if the prospective customer has previously affirmatively agreed to be contacted by the user for the purpose of providing such proposals. In other embodiments, the input keys 804 and 806 may only be displayed or configured to be activated if the prospective customer has not previously received a proposal communication within a predetermined time period. For example, the customer identification module 20 may be configured to only allow a communication once every thirty days. Thus, if a communication has been communicated within the previous 30 days either the input keys will not be displayed in UI 800 or the input keys may not be activated.

Additionally, the prospective customer communication mechanism and history 802 portion of UI 800 includes history field 808 that displays the communication history for the prospective customer. The UI 800 may be configured to create and display an entry in history field 808 upon engaging either the send email input key 804 or the send text input key 806. In other embodiments, the user may be tasked with creating entries in the history field 808 based on activating input key 804 or 808 or communicating the proposal to the prospective customer in another manner, such via postal mail, telephone call, face-to-face or the like. Additionally, in those embodiments in which the input keys 804 and 806 are not restricted in use based on previous proposal communication entries in the history field 806 may serve the basis for making a decision on providing a further proposal communication. In those embodiments in which the history entry is not generated or if the automated entry requires further information, a user may implement input fields 810, 812 and 814 to supply the requisite and/or additional information. Input field 810 provides for entry of the user/sales associate name, input field 812 provides for entry of the date of the communication and input field 814 provides for entry of comments related to the communication proposal.

In alternate embodiments of the invention, social media may be implemented as a means of communications, including but not limited to terms of vehicle transactions, to prospective customers and/or contacting new or existing customers. Social media is defined as a means of interactions among individuals or entities, such as companies, in which they create, share, and exchange information and ideas in virtual communities and communication networks. Examples of presently known social media available through the Internet include Facebook®, Twitter®, Pinterest® and the like. Other known or future known social media are also considered to be within the scope of the herein disclosed embodiments of the invention.

In certain embodiments of the invention, the potential vehicle proposal may be communicated to the prospective customer via social media. In certain instances, previous customers or new customers may have previously indicated that they authorize or otherwise desire to be contacted via social media. Previous customers may have indicated such on a survey or questionnaire provided to the former customer at the time of their previous vehicle purchase/lease or at a subsequent point in time. In which case, such indication may be stored in a customer profile that is accessible to the customer proposal modules herein disclosed. In other instances, a former or new customer may “friend”, “like” or otherwise become affiliated with the vehicle seller's presence on the social media website. In such instances, the affiliation alone may provide the authorization necessary to contact the prospective customer with potential vehicle proposals, while in other instances the affiliation may trigger communication of a survey to the social media-affiliated prospective customer which asks the prospective customer if they desire to be contacted with potential vehicle proposals and, if so, which communication channel or channels, including social media channels email, texts or the like, they desire to be contacted with the proposals.

In other embodiments of the invention, the user, such as a dealership or the like may be unaware of a prospective customer's social media presence. For example, the user may be unaware of whether a prospective customer has a Facebook® account, a Twitter® account or the like. However, the user may have access to customer-related data, such as an email address, a telephone number or the like that is associated with the social media account and is configured to identify the account and, in some instances, provide limited or full access to the account. Therefore, in accordance with specific embodiments of the invention the user may provide entry (such as via a direct feed from a customer profile database) or manual entry of customer-related data to social media search engines to identify a specific customer having an account with the social media entity or all of the customers within the user's customer database, or a database accessible to the user, that have an account with the social media entity. If a prospective customer is determined to have an account, the user may attempt to contact the prospective customer via the social media entity, such as by sending a “friend” or “like” request, posting an entry on a posting feed, such as Twitter® feed or the like. Once the prospective customer has accepted the request or otherwise positively responded to a request or a posting, the user may communicate a survey or questionnaire to the prospective customer, via the social media channel or any other known communication channel of the potential user (e.g., email, text, telephone or the like) asking the prospective customer if communications about the vehicles can be communicated to the prospective customer and, if so, the prospective customers desired communication channel or channels, including the social media channel, email addresses, text/telephone numbers or the like.

In further embodiments of the invention, once the prospective customer has been identified as having a social media account and, in some embodiments has granted the user access to the account, such as ‘friending” the user, the user may automatically, or in some embodiments manually, monitor the prospective customers social media account for activity that indicates the prospective customer's interest in buying or leasing a vehicle and, specifically, a vehicle that is currently available to the user. For example, the prospective customer may “pin” a vehicle to a virtual bulletin board or post entries showing an interest in acquiring a new vehicle. Providing access to the account may authorize the user to monitor the account of the user may be required to acquire further approval from the prospective customer to monitor their account. Once such monitoring results in an indication that the customer has an interest in a vehicle, such indication may trigger a communication to be generated and/or communicated to the customer. In specific embodiments, such a communication may be generated and communicated to the customer if the user has access to the customer's related-information, such as the customer's current vehicle, the customer's current financing obligations related to their current vehicle or other data that might indicate the possible intent of the customer. In other embodiments of the invention, indication that the customer has an interest in a vehicle may trigger the user to obtain the customer's information for the purpose of determining potential transaction terms. In such instances, the user may send communications to the prospective customer asking for such information and/or send communications to third-party entities that have access to such information and are otherwise authorized to provide for such information to the user.

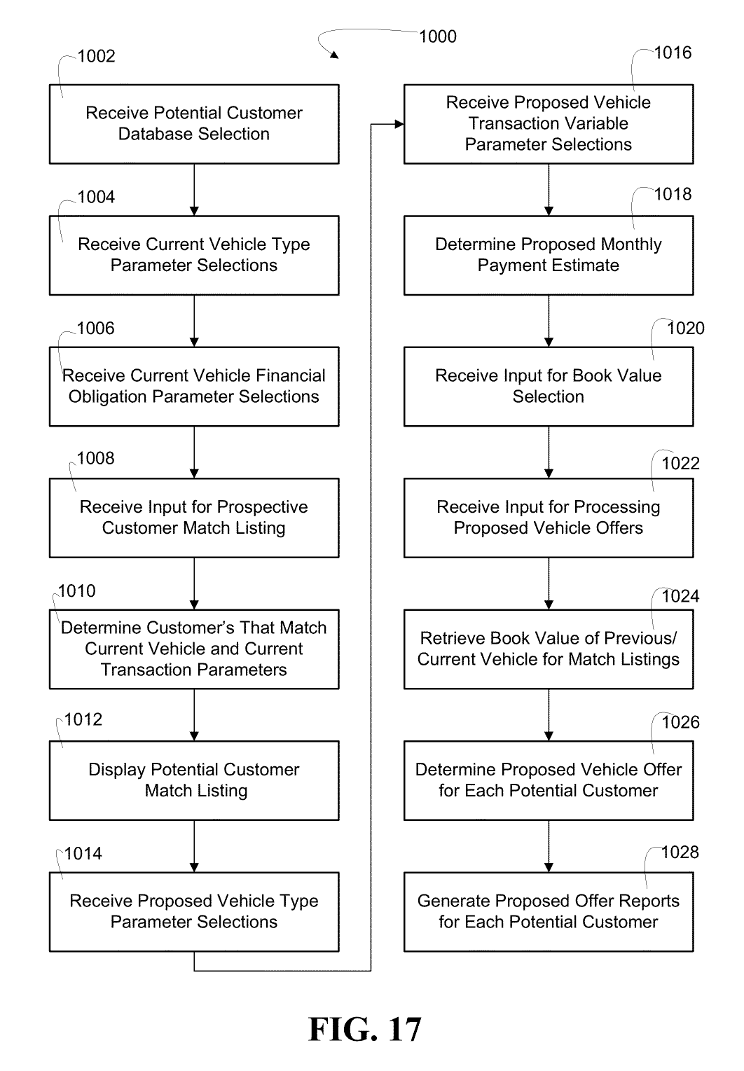

Turning to FIG. 17, a flow diagram is presented of a method 1000 for generating potential vehicle communications, in accordance with an embodiment of the present invention. At Event 1002, an input is received, at a predetermined UI, such as the UI discussed in relation to FIG. 8, to select a database for searching of prospective customers. The selected database may be associated with a specific dealership business unit, a grouping of dealership business units, a manufacturer or the like. In one embodiment the selected database is further defined as a previous customer database, such that prospective customers come from a pool of previous purchase, lease and/or service customers.

At Event 1004, input(s) are received, typically at the same predetermined UI associated with Event 1102, which selects one or more vehicle type parameters for the vehicle currently owned/leased by the prospective customers. The current vehicle type parameters may include, but are not limited to, make, model, year, model number, body type and the like. By selecting one or more current vehicle type parameters the prospective customer search is limited to those customers currently under a financial obligation, e.g., a loan or a lease, associated with the selected type of vehicle. For example, if the user selects Make—Honda, Model—Accord and Year—2006, the prospective customer search is limited to those prospective customers currently having a financial obligation associated with a 2006 Honda Accord.

At Event 1006, input(s) are received, typically at the same predetermined UI associated with Events 1002 and 1004, that selects one or more current or ongoing financial obligation parameters. Financial obligation parameters may include, but are not limited to, a minimum and/or maximum finance rate, a minimum and/or maximum monthly payment amount, the year the financial obligation started, the year the financial obligation is due to end, a minimum payment term, a maximum payment term, a minimum money factor, a maximum money factor and the salesperson associated with the previous vehicle transaction. In this regard, by selecting one or more financial obligation parameters the prospective customer search is limited to those customers currently under a financial obligation meeting the selected financial obligation criteria. It should be noted that in certain embodiments, only Event 1004 or Event 1006 needs to occur. In other words, the user may only limit the search of prospective customers based on vehicle type or current financial obligation parameters, as opposed to limiting the search for prospective customers based on both vehicle type and current financial obligation parameters.

At Event 1008, an input is received to search the selected database for prospective customers based on the selected vehicle type parameters and/or selected previous financial obligation parameters. At Event 1010, based on the input at Event 1008, a determination is made as to which customers match or meet the selected vehicle type criteria and/or selected previous financial obligation parameters. Those customers that meet or match the selected vehicle type criteria and/or selected previous financial obligation parameters form a group of prospective customers that may be targeted for customized potential vehicle proposals. At optional Event 1012, a listing of the customers that match or meet the selected vehicle type criteria and/or selected previous financial obligation parameters may be displayed. An example of the formatting of a customer listing panel is shown and described in relation to FIG. 9.

At Event 1014, input(s) are received, at a predetermined UI such as the UIs discussed in relation to FIGS. 10 and/or 11, that select one or more proposed vehicle type parameters. The proposed vehicle is the vehicle that the user desires to propose for sale or lease to the group of prospective customers and is the vehicle for which the user is determining a customized potential vehicle proposal for each of the prospective customers. The proposed vehicle type parameters may include, but are not limited to, make, model, year, model number, body type and the like. Alternatively, the user may choose to select the proposed vehicle from a listing of available vehicles.

At Event 1016, input(s) are received, typically at the same predetermined UI associated with Event 1114, that select or define one or more proposed vehicle transaction parameters. The selected or defined proposed vehicle transaction parameters will differ depending on whether the proposal is being structured as a sale or as a lease. For a sale, the vehicle transaction parameters may include, but are not limited to, a desired sale price, current financial rate being offered, a payment term, a minimum desired profit on the sale, a manufacturer incentive associated with the sale, a variance amount above the current payment amount and a minimum equity position associated with the current vehicle. For a lease, the vehicle transaction parameters may include, but are not limited to, a Manufacturer's Selected Retail Price (MSRP), a base cap cost, a minimum desired profit on the lease, acquisition fees, a minimum cash down amount, a residual rate, a term of lease, money factor, a variance amount above the current payment amount and/or a minimum equity position associated with the current vehicle. It should be noted that selection of the vehicle and selection of certain variable vehicle transaction parameters, such as the variance amount above the current payment amount and the minimum equity position associated with the current vehicle, will further limit the group of prospective customers that will be targeted with a customized potential vehicle proposal.

At optional Event 1018, a proposed monthly payment estimate is determined and, optionally, displayed on the UI, for the purpose of making the user aware of what the monthly payment is estimated based on other parameters for the proposed vehicle that will be offered to the prospective customers. The proposed monthly payment estimate is determined based on information selected or defined at Event 1016, such as for a sale, sales price, finance rate and term, and for a lease, residual, term and money factor along with a calculated adjusted cap cost.

At Event 1020, an input is received, typically at the same predetermined UI associated with Event 1014, which selects a book value to be used in determining the market value of the prospective customer's current vehicle. The estimated market value of the customer's current vehicle will be determined during the process that determines the customized potential vehicle proposal for each of the prospective customers.

At Event 1022, an input is received, typically at the same predetermined UI associated with Event 1014, to process the potential vehicle proposal for each of the identified prospective customers. At Event 1024, a customer vehicle market value and/or data effecting vehicle market value is retrieved from an external database, such as BlackBook®, CarFax® or the like, for each of the prospective customers. The customer vehicle market value may be based on the selected book value (Event 1020) and any other retrieved information such as service information that may indicate recent mileage on the vehicle or the like. The customer vehicle market value is subsequently used to determine the potential vehicle proposal that will be offered to each of the prospective customers.

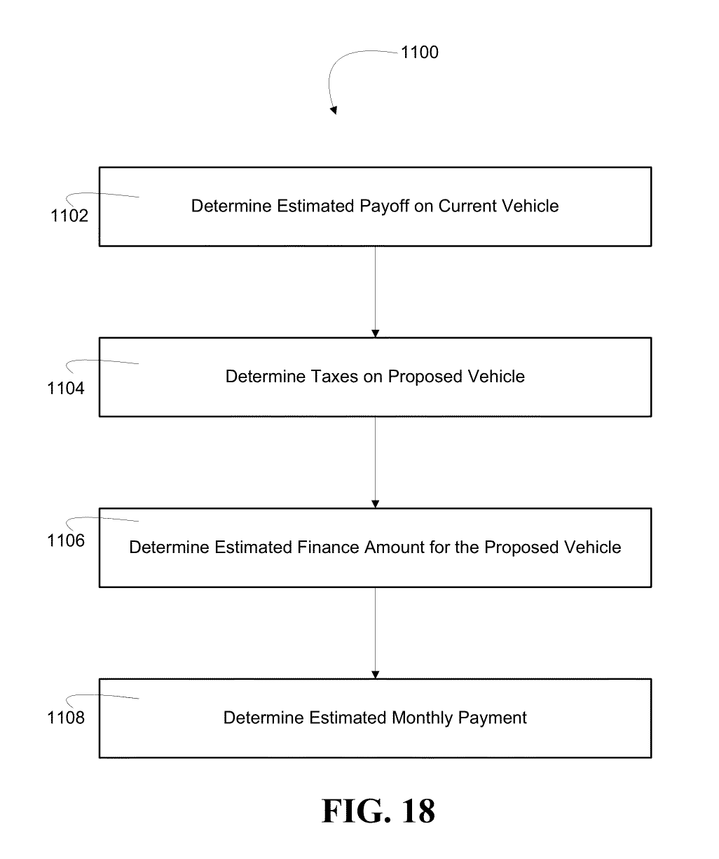

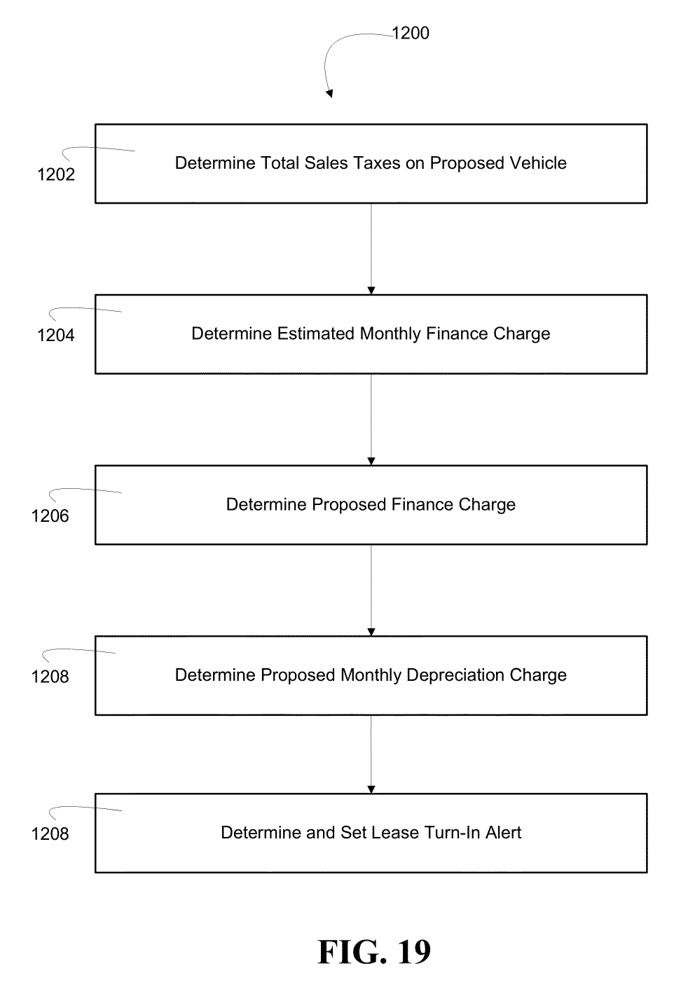

At Event 1026, a potential vehicle proposal is determined for each of prospective customers. The flow diagram 1100 of FIG. 18, discussed infra., describes an exemplary vehicle sales proposal determination process and the flow diagram 1200 of FIG. 19, discussed infra., describes an exemplary vehicle potential lease terms determination process. At Event 1028, based on the determination of potential vehicle proposals, potential vehicle proposal reports are generated for each of the prospective customers. In accordance with an embodiment of the present invention, the potential vehicle proposal reports may be electronically communicated to designated individuals/salespeople within the sales company. In addition, the system may provide for generating and electronically communicating, via e-mail, text message or the like the proposed offer to each of the prospective customers that have an address or number associated with an electronic delivery mechanism. In other embodiments, the system may provide for generating prospective customer letters, through use of a letter template, that include the proposal and that are subsequently communicated to the prospective customer via postal service or the like.

Referring to FIG. 18, a flow diagram is presented of a method 1100 for determining a targeted and customized retail/sales proposal for identified prospective customers, in accordance with embodiments of the present invention. The events herein described in relation to FIG. 18 are performed for each identified prospective customer so as to create customized sales proposals for each of the identified prospective customers. At Event 1102, an estimated payoff on the current vehicle is determined based on the current customer term, the finance rate of the ongoing financial obligation, the amount financed and the number of estimated payments made since the contract data. At Event 1104, taxes are determined for the proposed vehicle sale. The determined taxes are based on the sales price of the vehicle, the vehicle market book value and the state sales tax rate. The result of the determination may then be checked to see if it is within the customer's state tax allowable limits. If the determined tax is higher than the maximum allowable tax, the maximum allowable tax will be used in the proposal as the vehicle tax.

At Event 1106, an estimated finance amount for the proposed vehicle is determined. The estimated finance amount is based on information inputted by the user related to the proposed vehicle transaction parameters. This information includes, the desired sales price, the minimum profit on the sale, the calculated estimate payoff on the current vehicle (Event 1102), the manufacture's incentive, the book value of the current vehicle, and the taxes, title, license and documentation fees associated with the proposed vehicle.

At Event 1108, an estimated monthly payment is determined based on determined estimated finance amount (Event 1106), the identified term of the loan and the finance rate of the loan.

Referring to FIG. 19, a flow diagram is presented of a method 1200 for determining a targeted and customized potential lease terms for identified prospective customers, in accordance with embodiments of the present invention. The events herein described in relation to FIG. 19 are performed for each identified prospective customer so as to create customized potential lease terms for each of the identified prospective customers. At Event 1202, a total sales tax is determined for the proposed vehicle based on the MSRP price of the vehicle, the vehicle market book value and the state sales tax rate. The result of the determination may then be checked to see if it is within the customer's state tax allowable limits. If the determined tax is higher than the maximum allowable tax, the maximum allowable tax will be used in the proposal as the vehicle tax.

At Event 1204, an estimated monthly finance charge is determined. The estimated monthly finance charge is based on the proposed financed amount, proposed residual value, term and money factor. The monthly finance charge is calculated as the sum of the proposed vehicle monthly depreciation fee, plus the monthly finance fee. It should be noted that this calculation does not take into account sales taxes. The monthly depreciation fee is calculated as the proposed finance amount (adjusted cap cost, item 638 of FIG. 11) minus the variable proposed residual (item 642 of FIG. 11) divided by the lease term (item 644 of FIG. 11). The monthly finance fee is calculated as the proposed financed amount (adjusted cap cost, item 638 of FIG. 11) plus the proposed vehicle residual (item 642 of FIG. 11) multiplied by the money factor amount (item 648 of FIG. 11).

At Event 1206, a proposed finance charge is determined based on the calculated estimated monthly charge (Event 1204) and the term of the lease. At Event 1208 a proposed monthly depreciation charge is determined based on the proposed depreciation (i.e., the residual amount) and the term of the lease. The monthly depreciation fee is calculated as the proposed finance amount (adjusted cap cost, item 638 of FIG. 11) minus the variable proposed residual (item 642 of FIG. 11) divided by the lease term (item 644 of FIG. 11).

At Event 1208, a lease turn-in notification is determined. The lease turn-in notification is based on the estimated payoff amount and the estimated money owed. The turn-in warning is activated when the estimated money owed is less than the negative equity (i.e., the payoff amount minus the vehicle market value).

The embodiments of the invention herein disclosed provide for efficient identification of previous customers based on their current vehicle and/or their previous, and in some instances, ongoing financial obligation related to the current vehicle. A new or pre-owned vehicle is identified and a financial transaction proposal, such as a sales or potential lease terms, is generated for one or more of the identified previous customers based on customers meeting criteria associated with variable parameters of the proposed transaction.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for verifying a trade-in amount that a user can offer a customer for an item desired to be traded-in, the system comprising:
a computing platform having a memory and a processor in communication with the memory;
a customer database stored in the memory, accessible by the processor and configured to store customer information for a plurality of customers, wherein the customer information includes information related to items currently possessed by the customers; and
a potential buyer identifier application stored in the memory, executable by the processor and configured to determine a quantity of potential buyers for a trade-in item, wherein the potential buyers are determined by accessing the customer database to identify customers currently possessing similar items to the trade-in item,
wherein the quantity of potential customers is used to determine whether a trade-in amount for the trade-in item may be offered to the customer as part of a deal associated with the trade-in item.

2. An apparatus for locating information used by a vehicle dealer in determining a trade-in vehicle amount that the vehicle dealer may offer a customer having a trade-in vehicle, the apparatus comprising:
at least one computing device having a memory and a processor in communication with the memory;
a potential buyer identifier application stored in the memory, executable by the processor and configured to determine, while the customer is negotiating a vehicle deal, a quantity of potential buyers for the trade-in, wherein the potential buyers are determined based on information available to the vehicle dealer that relates to potential buyers who have a current vehicle that is similar in at least one respect to the trade-in vehicle; and
a trade-in vehicle amount determination application stored in the memory, executable by the processor and configured to determine the trade-in vehicle amount that may be offered to the customer while the customer is negotiating the vehicle deal based on the quantity of potential buyers that are determined.

3. The apparatus of claim 2, wherein the potential buyer identifier application is further configured to determine the quantity of potential buyers based on the potential buyers being able to be offered the trade-in vehicle at one of a same monthly payment amount or a lower monthly payment amount than the potential buyer currently pays for his/her current vehicle.

4. The apparatus of claim 2, wherein the potential buyer identifier application is further configured to determine the quantity of potential buyers based on the potential buyers having a current vehicle that is a same make and model and a same or earlier model year as the trade-in vehicle.

5. The apparatus of claim 2, wherein the potential buyer identifier application is further configured to determine the quantity of potential buyers based on current financing status of a current vehicle possessed by the one or more potential buyers.

6. The apparatus of claim 5, wherein the potential buyer identifier application is further configured to determine the quantity of potential buyers based on at least one of a current amount outstanding on a loan or lease of the current vehicle, a number of payments remaining on the loan or lease of the current vehicle, and historical payment data indicating timeliness of making payments for the current vehicle.

7. The apparatus of claim 2, wherein the potential buyer identifier application is further configured to determine the quantity of potential buyers based on non-vehicle related financial information associated with the potential buyers.

8. The apparatus of claim 7, wherein the potential buyer identifier application is further configured to determine the quantity of potential buyers based on at least one of current job status of the potential buyers, current salary/income of the potential buyers, current savings amounts of the potential buyer, and bankruptcy status of the potential buyers.

9. The apparatus of claim 2, wherein the potential buyer identification application is further configured to determine an identity for each of the potential buyers.

10. The apparatus of claim 2, wherein the trade-in vehicle amount is further configured to determine the trade-in vehicle amount, wherein the trade-in vehicle amount reflects a price at which the vehicle dealer should be able to re-sell the trade-in vehicle.

11. The apparatus of claim 2, wherein the trade-in vehicle amount is further configured to determine the trade-in vehicle amount, wherein the trade-in vehicle amount reflects a recondition amount.

12. A method for determining or verifying a trade-in vehicle amount that a vehicle dealer may offer a customer having a trade-in vehicle, the method comprising:
identifying at least one of (1) the trade-in vehicle and (2) a proposed trade-in vehicle amount for the trade-in vehicle;
determining, by a computing device, a quantity of potential buyers for the trade-in vehicle, wherein the potential buyers are determined based on information available to the vehicle dealer that relates to potential buyers who have a current vehicle that is similar in at least one respect to the trade-in vehicle; and
determining one of (1) a trade-in vehicle amount for the vehicle that may be offered to the customer based on the quantity of potential buyers, or (2) that the proposed trade-in vehicle amount may be offered to the customer having the trade-in vehicle based on the quantity of the potential buyers.

13. The method of claim 12, wherein determining a trade-in vehicle amount for the vehicle further comprises determining, by a computing device, the trade-in vehicle amount for the trade-in vehicle that may be offered to the customer based on the quantity of the potential buyers.

14. The method of claim 12, further comprising determining an identity for each potential buyer.

15. The method of claim 12, wherein determining the quantity of potential buyers for the vehicle further comprises determining, by a computing device, the quantity of potential buyers based on the potential buyers having a current vehicle that is a same make and model and a same or earlier model year as the trade-in vehicle.

16. The method of claim 12, wherein determining the quantity of potential buyers for the vehicle further comprises determining, by a computing device, the quantity of potential buyers based on the potential buyers being able to be offered the trade-in vehicle at one of a same monthly payment amount or a lower monthly payment amount than the potential buyer currently pays for his/her current vehicle.

17. The method of claim 12, wherein determining the quantity of potential buyers for the vehicle further comprises determining, by a computing device, the quantity of potential buyers based on current financing status of current vehicle possessed by the one or more potential buyers.

18. The method of claim 17, wherein determining the quantity of potential buyers for the vehicle further comprises determining, by a computing device, the quantity of potential buyers based on at least one of a current amount outstanding on a loan or lease of the current vehicle, a number of payments remaining on the loan or lease of the current vehicle, and historical payment data indicating timeliness of making payments for the current vehicle.

19. The method of claim 12, wherein determining the quantity of potential buyers for the vehicle further comprises determining, by a computing device, the quantity of potential buyers based on non-vehicle related financial information associated with the potential buyers.

20. The method of claim 19, wherein determining the quantity of potential buyers for the vehicle further comprises determining, by a computing device, the quantity of potential buyers based on at least one of current job status of the potential buyers, current salary/income of the potential buyers, current savings amounts of the potential buyer, and bankruptcy status of the potential buyers.

21. The method of claim 12, wherein determining the potential buyers for the vehicle, determining the trade-in vehicle amount for the vehicle and determining that the proposed trade-in vehicle amount can be offered to the customer all occur while the customer is currently negotiating the vehicle deal.

22. A computer program product, the computer program product comprising a non-transitory computer-readable medium having computer-executable instructions to cause a computer to implement the steps of:
determine a quantity of potential buyers for an identified trade-in vehicle sought to be traded-in by a customer, wherein the potential buyers are determined based on information available to the vehicle dealer that relates to potential buyers who have a current vehicle that is similar in at least one respect to the trade-in vehicle; and
determine the trade-in vehicle amount that may be offered to the customer having the trade-in vehicle based on the quantity of the potential buyers.

23. The computer program product of claim 22, wherein the step of determine the quantity of one or more potential buyers further comprises determining the quantity of potential buyers based on the potential buyers having a current vehicle that is a same make and model and a same or earlier model year as the trade-in vehicle.

24. The computer program product of claim 22, wherein the steps further include determine an identity of each potential buyer.

25. The computer program product of claim 22, wherein the step of determine the quantity of potential buyers further comprises determine the quantity of potential buyers based on the potential buyers being able to be offered the trade-in vehicle at one of a same monthly payment amount or a lower monthly payment amount than the potential buyer currently pays for their current vehicle.

26. The computer program product of claim 22, wherein the step of determine the quantity of potential buyers further comprises determine the quantity of potential buyers based on current financing status of a current vehicle possessed by the one or more potential buyers.

27. The computer program product of claim 26, wherein the step of determine the quantity of potential buyers further comprises determine the quantity of potential buyers based on at least one of a current amount outstanding on a loan or lease of the current vehicle, a number of payments remaining on the loan or lease of the current vehicle, and historical payment data indicating timeliness of making payments for the current vehicle.

28. The computer program product of claim 22, wherein the step of determine the quantity of potential buyers further comprises determine the quantity of potential buyers based on non-vehicle related financial information associated with the potential buyers.

29. The computer program product of claim 28, wherein the step of determine an identity of one or more potential buyers further comprises determine the quantity of potential buyers based on at least one of current job status of the potential buyers, current salary/income of the potential buyers, current savings amounts of the potential buyer, and bankruptcy status of the potential buyers.

30. The computer program product of claim 22, wherein the step of determine the trade-in amount further comprises determine the trade-in vehicle amount, wherein the trade-in vehicle amount reflects a price at which the vehicle dealer should be able to re-sell the trade-in vehicle.
